(19) United States
(12) Patent Application Publication
(10) Pub. No.: US 2024/0172272 A1
(43) Pub. Date: May 23, 2024

(54) MSG3 PHYSICAL UPLINK SHARED CHANNEL (PUSCH) REPETITION REQUESTS

(71) Applicant: Intel Corporation, Santa Clara, CA (US)

(72) Inventors: Gang Xiong, Portland, OR (US); Debdeep Chatterjee, San Jose, CA (US); Yingyang Li, Beijing (CN); Sergey Sosnin, Zavolzhie (RU); Gregory Ermolaev, Nizhny Novgorod (RU)

(21) Appl. No.: 18/549,526

(22) PCT Filed: May 5, 2022
(86) PCT No.: PCT/US2022/027909

§ 371 Date: Sep. 7, 2023

Related U.S. Application Data
(60) Provisional application No. 63/185,064, filed on May 6, 2021.

(51) Int. Cl. H04W 74/00; H04W 74/0833

(52) U.S. Cl. CPC H04W 74/004; H04W 74/0833

(57) ABSTRACT

Various embodiments herein are directed to the request of Msg3 physical uplink shared channel (PUSCH) repetitions. In order to improve the coverage, repetition is supported for Msg3 PUSCH during the 4-step RACH procedure. In this case, either separate PRACH occasions or shared PRACH occasions with separate PRACH preambles may be configured to differentiate the enhanced UE that requests the Msg3 PUSCH repetition and legacy UEs that do not.

### CROSS REFERENCE TO RELATED APPLICATION

The present application claims priority to U.S. Provisional Patent Application No. 63/185,064, which was filed May 6, 2021.

### FIELD

Various embodiments generally may relate to the field of wireless communications. For example, some embodiments may relate to the request of Msg3 physical uplink shared channel (PUSCH) repetitions.

### BACKGROUND

Mobile communication has evolved significantly from early voice systems to today's highly sophisticated integrated communication platform. The next generation wireless communication system, 5G, or new radio (NR) will provide access to information and sharing of data anywhere, anytime by various users and applications. NR is expected to be a unified network/system that target to meet vastly different and sometime conflicting performance dimensions and services. Such diverse multi-dimensional requirements are driven by different services and applications. In general, NR will evolve based on 3GPP LTE-Advanced with additional potential new Radio Access Technologies (RATs) to enrich people lives with better, simple, and seamless wireless connectivity solutions. NR will enable everything connected by wireless and deliver fast, rich content and services.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIG. 1 illustrates an example of a 4-step RACH procedure in accordance with various embodiments.

FIGS. 2-5 illustrate examples of PRACH preambles for request of Msg3 PUSCH repetition and legacy RACH in accordance with various embodiments.

FIG. 6 illustrates an example of PRACH resource partitioning for non-RedCap and RedCap UEs with request of a Msg3 PUSCH repetition in accordance with various embodiments.

FIG. 7 schematically illustrates a wireless network in accordance with various embodiments.

FIG. 8 schematically illustrates components of a wireless network in accordance with various embodiments.

FIG. 9 is a block diagram illustrating components, according to some example embodiments, able to read instructions from a machine-readable or computer-readable medium (e.g., a non-transitory machine-readable storage medium) and perform any one or more of the methodologies discussed herein.

FIGS. 10, 11, and 12 depict examples of procedures for practicing the various embodiments discussed herein.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A or B” and “A/B” mean (A), (B), or (A and B).

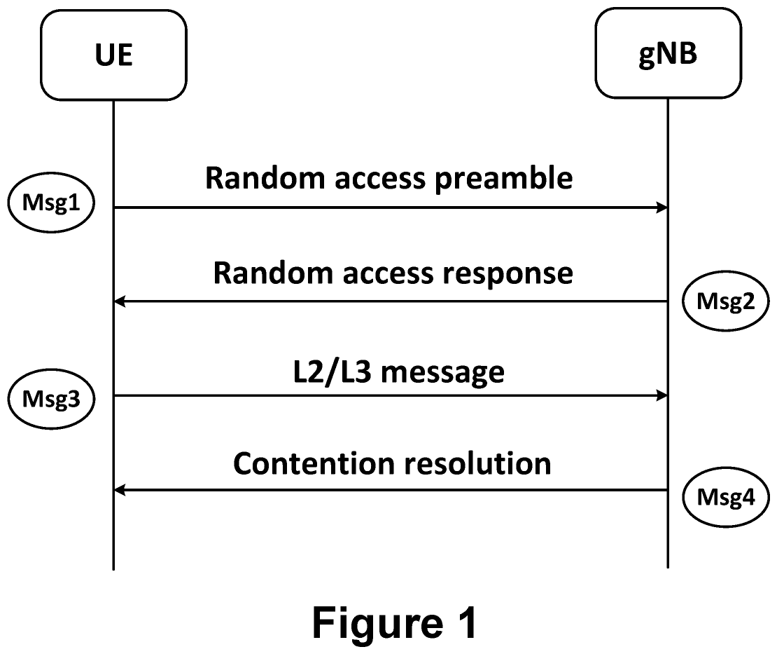

In Rel-15 NR, a 4-step random access channel (RACH) procedure was defined. As illustrated in FIG. 1, in the first step, a user equipment (UE) transmits a physical random access channel (PRACH) in the uplink by selecting one preamble signature. Subsequently, in the second step, a next-generation NodeB (gNB) feedbacks the random access response (RAR) which carries timing advanced (TA) command information and uplink grant for the uplink transmission. Further, in the third step, the UE transmits Msg3 physical uplink shared channel (PUSCH) which may carry a contention resolution ID. In the fourth step, the gNB sends the contention resolution message in physical downlink shared channel (PDSCH).

In order to improve the coverage, repetition is supported for Msg3 PUSCH during the 4-step RACH procedure. In this case, either separate PRACH occasions or shared PRACH occasions with separate PRACH preambles may be configured to differentiate the enhanced UE that requests the Msg3 PUSCH repetition and legacy UEs that do not. In particular, UEs who support Msg3 PUSCH repetition, and meanwhile need coverage enhancement, would transmit a PRACH preamble in the indicated PRACH resources. After successful detection of PRACH preambles in the configured resources, the gNB may indicate the repetition factor for Msg3 PUSCH transmission for enhanced UEs.

In case of shared PRACH occasions (RO), separate PRACH preambles can be used to differentiate the enhanced UEs who support the Msg3 PUSCH repetition and legacy UEs or UEs who do not need coverage enhancement. In this case, certain mechanisms may need to be considered in order to allocate the PRACH preambles for the enhanced UEs in case of the shared ROs. Among other things, some embodiments of the present disclosure are directed to the request of Msg3 PUSCH repetitions using separate PRACH resources.

### Request of Msg3 PUSCH Repetition Using Separate PRACH Resources

As mentioned above, in order to improve the coverage, repetition is supported for Msg3 PUSCH during 4-step RACH procedure. In this case, either separate PRACH occasions or shared PRACH occasions with separate PRACH preambles may be configured to differentiate the enhanced UE who request the Msg3 PUSCH repetition and legacy UE. In particular, UEs who support Msg3 PUSCH repetition and meanwhile need coverage enhancement would transmit PRACH preamble in the indicated PRACH resources. After successful detection of PRACH preambles in the configured resources, gNB may indicate the repetition factor for Msg3 PUSCH transmission for enhanced UEs.

In cases of shared PRACH occasions (RO), separate PRACH preambles can be used to differentiate the enhanced UEs who support the Msg3 PUSCH repetition and legacy UEs or UEs who do not need coverage enhancement. In this case, certain mechanisms may need to be considered in order to allocate the PRACH preambles for the enhanced UEs in case of the shared ROs.

Embodiment of request of Msg3 PUSCH repetition using separate PRACH resources are provided as follows:

In one embodiment, separate PRACH occasions can be configured for request of Msg3 PUCSH repetition for 4-step RACH. In this case, separate parameters for synchronization signal block (SSB) to RACH occasion (RO) association can be configured for enhanced UEs that request Msg3 PUSCH repetition and those for UEs that do not. If separate parameters for synchronization signal block (SSB) to RACH occasion (RO) associations are not configured, a common configuration for 4-step RACH can be reused while the ROs may be separately provided for enhanced UEs who request for Msg3 PUSCH repetition and those that do not.

Note that, here and in the rest of the disclosure, UEs that do not request Msg3 PUSCH repetition may be assumed to include UEs that do not support Msg3 PUSCH repetition.

In one example, when separate PRACH occasion is configured for request of Msg3 PUCSH repetition for 4-step RACH, the following text can be added in Section 8.1 in TS 38.213, v. 16.5.0, 2021-03-30.

For Type-1 random access procedure with request of Msg3 PUSCH repetition configured with separate configuration of PRACH occasions with Type-1 random access procedure, a UE is provided a number N of SS/PBCH block indexes associated with one PRACH occasion and a number P of contention based preambles per SS/PBCH block index per valid PRACH occasion by ssb-perRACH-OccasionAndCB-PreamblesPerSSB-Msg3Rep when provided; otherwise, by ssb-perRACH-OccasionAndCB-PreamblesPerSSB.

Further, in case of separate ROs, different PRACH formats can be configured for UEs who request of Msg3 PUCSH repetition for 4-step RACH and those that do not. In particular, prach-ConfigurationIndex can be separately configured for request of Msg3 PUSCH repetition in case of separate ROs. If prach-ConfigurationIndex is not separately configured, corresponding parameter configured for 4-step RACH is reused by UEs requesting Msg3 PUSCH repetition.

In one example, PRACH format 0 may be configured for normal UEs, while PRACH format 1 may be configured for enhanced UEs who request Msg3 PUSCH repetition. This may help in improving the PRACH detection performance even for cell edge UEs by using PRACH format 1.

In addition, the following parameters can be separately configured for request of Msg3 PUSCH repetition in case of separate ROs. If these parameters are not configured, corresponding parameters configured for normal UEs for 4-step RACH can be reused:
prach-RootSequenceIndex
zeroCorrelationZoneConfig
restrictedSetConfig
totalNumberOfRA-Preambles (note that if this parameter is absent, all 64 preambles are available for request of Msg3 PUSCH repetition)
msg1-FDM
msg1-FrequencyStart

In another embodiment, for shared PRACH occasions between enhanced UEs requesting Msg3 PUSCH repetitions and those that do not, a number of PRACH preambles can be separately provided for enhanced UEs requesting Msg3 PUCSH repetition for 4-step RACH.

More specifically, 64 preambles are defined for a PRACH occasion (RO). Further, total number of preambles for contention based random access (CBRA) and contention free random access (CFRA) is configured by totalNumberOfRA-Preambles, which is further divided into N sets. Each set of PRACH preambles is associated with one synchronization signal block (SSB). Within each set of PRACH preambles associated with same SSB, 4-step CBRA RACH preambles are first mapped, and followed by CBRA 2-step RACH preambles. The remaining preambles are allocated for CFRA.

In cases of shared ROs, PRACH preambles for enhanced UEs for request of Msg3 PUSCH repetition may be allocated after the PRACH preambles allocated after CBRA 4-step RACH and/or 2-step RACH. In particular, within the set of preambles associated with a same SSB, PRACH preamble for request of Msg3 PUSCH repetition can be allocated after CBRA 2-step RACH if 2-step RACH is configured or CBRA 4-step RACH.

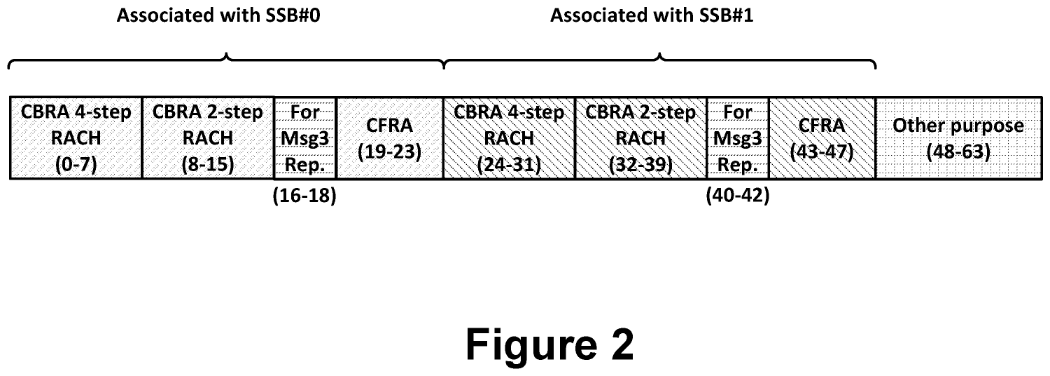

FIG. 2 illustrates one example of PRACH preambles for a request of a Msg3 PUSCH repetition and legacy RACH procedure. In the example, 2 SSBs are associated with one RO. In addition, preambles with index 0-23 are associated with SSB #0 and preambles with index 24-47 are associated with SSB #1. Further, within the preamble associated with a same SSB, PRACH preamble for request of Msg3 PUSCH repetition is allocated after CBRA 2-step RACH.

In one example, when shared PRACH occasion is configured for request of Msg3 PUSCH repetition and legacy 2-step and 4-step RACH, the following text can be added in Section 8.1 in TS 38.213.

For Type-1 random access procedure with request of Msg3 PUSCH repetition with common configuration of PRACH occasions with Type-1 random access procedure without request of Msg3 PUSCH repetition and with Type-2 random access procedure without request of Msg3 PUSCH repetition, if N<1, one SS/PBCH block index is mapped to 1/N consecutive valid PRACH occasions and M contention based preambles with consecutive indexes associated with the SS/PBCH block index per valid PRACH occasion start from preamble index R+Q. If N≥ 1, M contention based preambles with consecutive indexes associated with SS/PBCH block index n, 0≤n≤N−1, per valid PRACH occasion start from preamble index n·N_{preamble}^{total}/N+R+Q, where N_{preamble}^{total} is provided by totalNumberOfRA-Preambles for Type-1 random access procedure.

In another embodiment, if separate PRACH occasions for CBRA 2-step RACH are configured from legacy 4-step RACH, the preambles used for request of Msg3 PUSCH repetition are mapped after CBRA 4-step RACH preambles associated with one SSB

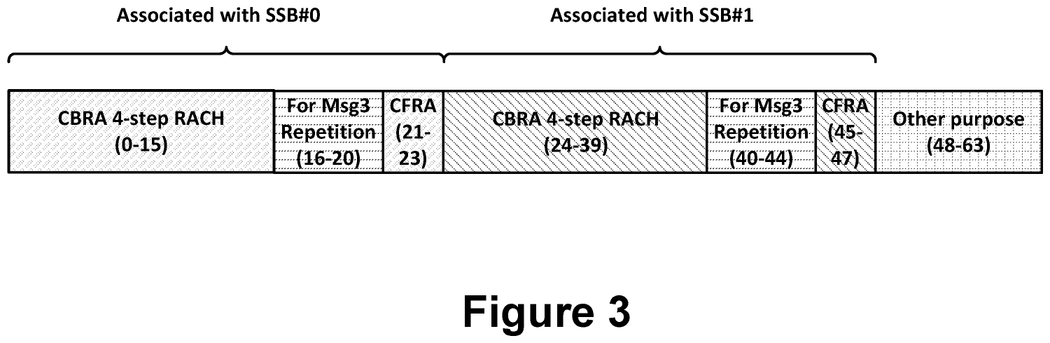

FIG. 3 illustrates one example of PRACH preambles for request of a Msg3 PUSCH repetition and legacy CBRA RACH procedure. In the example, 2 SSBs are associated with one RO. In addition, preambles with index 0-23 are associated with SSB #0 and preambles with index 24-47 are associated with SSB #1. Further, within the preamble associated with a same SSB, PRACH preamble for request of Msg3 PUSCH repetition is allocated after CBRA 4-step RACH.

In one example, when shared PRACH occasion is configured for request of Msg3 PUSCH repetition and legacy 4-step RACH, the following text can be added in Section 8.1 in TS 38.213.

For Type-1 random access procedure with request of Msg3 PUSCH repetition with common configuration of PRACH occasions with Type-1 random access procedure without request of Msg3 PUSCH repetition and with Type-2 random access procedure without request of Msg3 PUSCH repetition, if N<1, one SS/PBCH block index is mapped to 1/N consecutive valid PRACH occasions and M contention based preambles with consecutive indexes associated with the SS/PBCH block index per valid PRACH occasion start from preamble index R. If N≥1, M contention based preambles with consecutive indexes associated with SS/PBCH block index n, 0≤n≤N−1, per valid PRACH occasion start from preamble index n·N_{preamble}^{total}/N+R, where N_{preamble}^{total} is provided by totalNumberOfRA-Preambles for Type-1 random access procedure.

In another embodiment, in case of shared PRACH occasions, PRACH preambles for request of Msg3 PUSCH repetition are allocated within the preambles for legacy CBRA 4-step RACH. Further, PRACH preambles for request of Msg3 PUSCH repetition are mapped after the these for legacy CBRA 4-step RACH procedure, but before these for legacy CBRA 2-step RACH procedure.

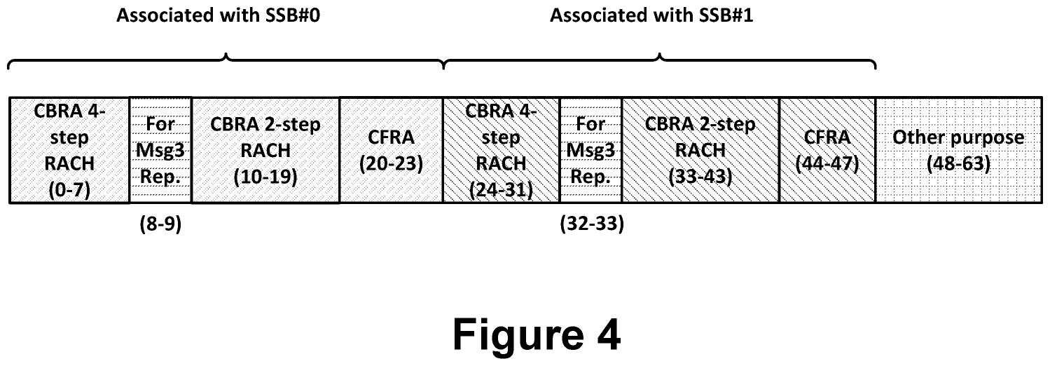

FIG. 4 illustrates one example of PRACH preambles for a request of Msg3 PUSCH repetition and legacy RACH. In the example, 2 SSBs are associated with one RO. In addition, preambles with index 0-23 are associated with SSB #0 and preambles with index 24-47 are associated with SSB #1 for legacy 4-step RACH and 2-step RACH. Further, within each set of preambles associated with an SSB, preambles for request of Msg3 PUSCH repetition are allocated after preambles for CBRA 4-step RACH and before preambles for CBRA 2-step RACH.

In another embodiment, in case of shared PRACH occasions, PRACH preambles for request of Msg3 PUSCH repetition are allocated within the preambles for other purpose, e.g., from totalNumberOfRA-Preambles to 63 within a RO.

Further, the preambles for request of Msg3 PUSCH repetition within these for other purpose are partitioned into multiple sets, where each set is associated with an SSB. The number of sets is determined by ssb-perRACH-OccasionAndCB-PreamblesPerSSB. Each set of preambles are allocated for request of Msg3 PUSCH repetition.

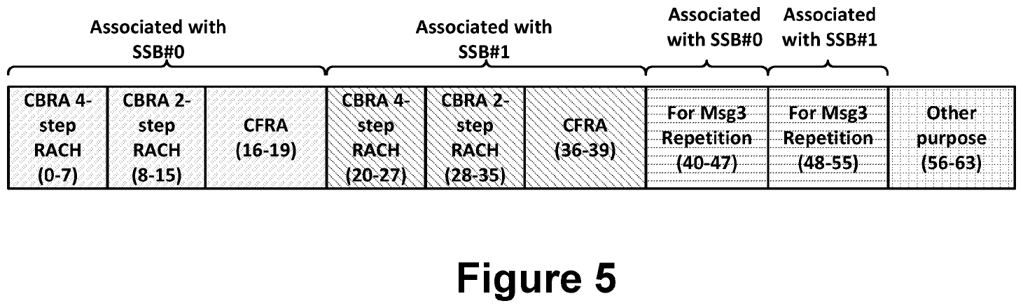

FIG. 5 illustrates one example of PRACH preambles for a request of Msg3 PUSCH repetition and legacy RACH. In the example, 2 SSBs are associated with one RO. In addition, preambles with index 0-19 are associated with SSB #0 and preambles with index 20-39 arc associated with SSB #1 for legacy 4-step RACH and 2-step RACH. Further, preambles for request of Msg3 PUSCH repetition are allocated within preambles for other purposes, e.g., from index 40-63. Similarly, two sets of preambles for request of Msg3 PUSCH repetition are allocated within the preambles for other purposes, where each set is associated with an SSB.

In another embodiment, UE may request different number of repetitions for Msg3 PUSCH repetition. In this case, additional PRACH resource partitioning may be configured within the PRACH resources for request of Msg3 PUSCH repetition

In one example, when two repetition levels are configured for request of Msg3 PUSCH repetition, the PRACH resources for request of Msg3 PUSCH repetition are divided into two parts, where the first part of the PRACH resources corresponds to request of Msg3 PUSCH repetition with a first repetition level and second part of the PRACH resources corresponds to request of Msg3 PUSCH repetition with a second repetition level.

Note that this may apply for the case when separate ROs and/or separate PRACH preambles in case of shared ROs are configured for request of Msg3 PUSCH repetition.

In another embodiment, when RACH based small data transmission (RA-SDT) is configured for RRC_INACTIVE UEs, and in case when shared ROs are used for RA-SDT, legacy RACH and request of Msg3 PUSCH repetition, the preambles for request of Msg3 PUSCH repetition can be allocated after PRACH preambles for 4-step RACH based RA-SDT within each set of PRACH preambles associated with the same SSB.

In another option, when RACH based small data transmission (RA-SDT) is configured for RRC_INACTIVE UEs, and in case when shared ROs are used for RA-SDT, legacy RACH and request of Msg3 PUSCH repetition, the preambles for request of Msg3 PUSCH repetition can be allocated after preambles for legacy CBRA 4-step RACH and before PRACH preambles for 4-step RACH based RA-SDT within each set of PRACH preambles associated with the same SSB.

In another option, when RACH based small data transmission (RA-SDT) is configured for RRC_INACTIVE UEs, and in case when shared ROs are used for RA-SDT, legacy RACH and request of Msg3 PUSCH repetition, the preambles for request of Msg3 PUSCH repetition can be allocated within preambles for CFRA and after the preambles for 2-step RACH based RA-SDT within each set of PRACH preambles associated with the same SSB.

Note that the above embodiments can be straightforwardly extended to the case when 2-step RACH procedure is used for request of Msg3 PUSCH repetition.

In another embodiment, when shared PRACH occasion is configured for request of Msg3 PUSCH repetition and legacy 2-step and 4-step RACH, a subset of ROs associated with the same SS/PBCH block index, within an SSB-RO mapping cycle, can be shared. A bitmap can be defined similar to msgA-ssb-sharedROmaskindex or mask index values defined in Table 7.4-1, which can be used to indicate that the subset of ROs for request of Msg3 PUSCH repetition shared with 4-step RACH and/or 2-step RACH, if not configured then all ROs for request of Msg3 PUSCH repetition are shared with 4-step RACH and/or 2-step RACH.

In another embodiment, the above embodiments can also apply to differentiate reduced capability (RedCap) UEs and non-RedCap UEs. In particular, separate PRACH resources in case of shared ROs and separate ROs can be configured by higher layers to differentiate RedCap UEs and non-RedCap UEs. Further, additional PRACH resource partitioning may be considered to differentiate one or multiple types of RedCap UEs that may or may not request for Msg3 PUSCH repetition and non-RedCap UEs that may or may not request for Msg3 PUSCH repetition. A RedCap UE may be identified as:
RedCap UE that does not support Msg3 PUSCH repetition and/or in coverage enhanced condition; or
RedCap UE that support Msg3 PUSCH repetition and in coverage enhanced condition, and request Msg3 PUSCH repetition (in the following, this combination of conditions is compactly represented by a “RedCap UE that requests for Msg3 PUSCH repetition”)

Alternatively, a RedCap UE may be identified as
RedCap UE that supports a maximum of one Rx branch or a maximum of one downlink (DL) MIMO layer and does not request Msg3 PUSCH repetition; or
RedCap UE that supports a maximum of one Rx branch or a maximum of one DL MIMO layer and requests Msg3 PUSCH repetition; or
RedCap UE that supports up to two Rx branches or a maximum of two DL MIMO layers and does not request for Msg3 PUSCH repetition; or
RedCap UE that supports up to two Rx branches or a maximum of two DL MIMO layers and requests Msg3 PUSCH repetition.

Similarly, a non-RedCap UE may be identified as:
Non-RedCap UE that does not request Msg3 PUSCH repetition; or
Non-RedCap UE that requests Msg3 PUSCH repetition.

In one option, in case of shared ROs between request of Msg3 PUSCH repetition for RedCap and non-RedCap UEs, PRACH preambles for enhanced non-RedCap UEs and RedCap UEs for request of Msg3 PUSCH repetition may be allocated after the preambles allocated for CBRA 4-step RACH and/or 2-step RACH. In particular, within the set of preambles associated with a same SSB, PRACH preamble for request of Msg3 PUSCH repetition for non-RedCap UEs is allocated after CBRA 2-step RACH and followed by request of Msg3 PUSCH repetition for RedCap UEs. Note that permutation of PRACH resource ordering for RedCap and non-RedCap UEs for request of Msg3 PUSCH repetition can be straightforwardly extended from the above option.

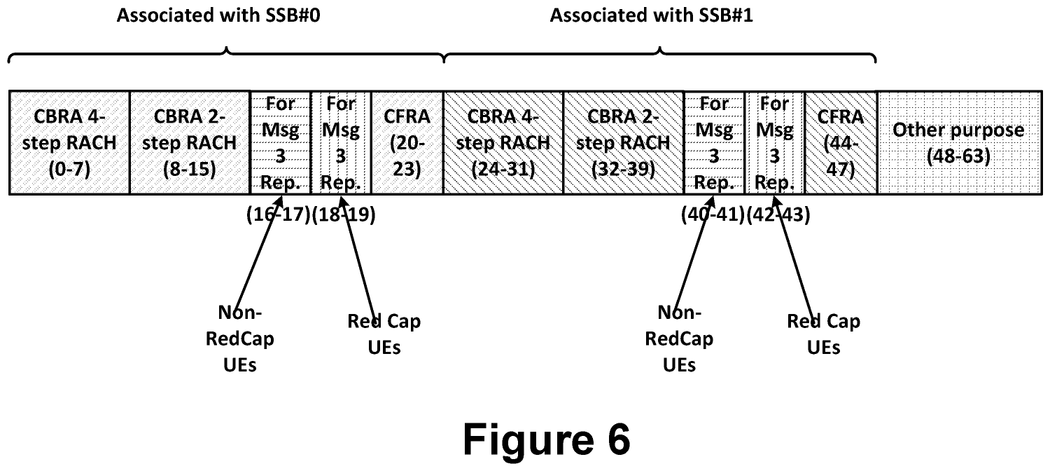

FIG. 6 illustrates one example of PRACH preambles for a request of Msg3 PUSCH repetition and legacy RACH procedure for non-RedCap and RedCap UEs. In the example, 2 SSBs are associated with one RO. In addition, preambles with index 0-23 are associated with SSB #0 and preambles with index 24-47 are associated with SSB #1. Further, within the preamble associated with a same SSB, PRACH preamble for request of Msg3 PUSCH repetition for non-RedCap UEs is allocated after CBRA 2-step RACH and followed by request of Msg3 PUSCH repetition for RedCap UEs

In another option, in case of shared ROs between request of Msg3 PUSCH repetition for RedCap and non-RedCap UEs, if a RO is also shared with non-RedCap UEs not requesting Msg3 PUSCH repetition, then the RO is also shared with RedCap UEs not requesting Msg3 PUSCH repetition. In other words, if a RO is shared between non-RedCap UEs and RedCap UEs either requesting Msg3 PUSCH repetitions or not, and possibly also shared with Type-2 random access procedure, within the set of preambles associated with a same SSB, PRACH preamble for request of Msg3 PUSCH repetition for non-RedCap UEs is allocated after PRACH preamble for CBRA 2-step RACH (Type-2 random access procedure), and is followed by PRACH preamble for RedCap UEs not requesting Msg3 PUSCH repetition, and then followed by PRACH preamble for requesting Msg3 PUSCH repetition for RedCap UEs.

In another example, if a RO is shared between non-RedCap UEs and RedCap UEs either requesting Msg3 PUSCH repetitions or not, and possibly also shared with Type-2 random access procedure, within the set of preambles associated with a same SSB, PRACH preamble for RedCap UEs not requesting Msg3 PUSCH repetition is allocated after PRACH preamble for CBRA 2-step RACH (Type-2 random access procedure), and is followed by PRACH preamble for RedCap UEs not requesting Msg3 PUSCH repetition, then followed by PRACH preamble for request of Msg3 PUSCH repetition for non-RedCap UEs, and then followed by PRACH preamble for requesting Msg3 PUSCH repetition for RedCap UEs.

In another embodiment, identification between RedCap and non-RedCap UEs may only be realized via separate PRACH occasions while identification between requesting Msg3 PUSCH repetitions or not for either RedCap or non-RedCap UEs respectively may be realized via partitioning of PRACH preambles. Alternatively, for either RedCap or non-RedCap UEs, identification between requesting Msg3 PUSCH repetitions or not may be realized via partitioning of PRACH resources while RedCap and non-RedCap UEs may only be identified via separate PRACH occasions or at a latter stage that may include during Msg3 transmission or as part of UE capability reporting.

In another embodiment, when a RedCap UE may be provided with separate initial Uplink (UL) BandWidth Part (BWP) or separate PRACH occasions (ROs) from that for non-RedCap UEs and when ROs are shared between RedCap UEs that request Msg3 PUSCH repetition and RedCap UEs that do not, PRACH preambles may be partitioned for the identification of RedCap UEs requesting Msg3 PUSCH repetition using one or a combination of approaches described above for identification between non-RedCap UEs that request Msg3 PUSCH repetition and non-RedCap UEs that do not, e.g., as in examples in FIGS. 2 and 3.

In yet another embodiment, when a RedCap UE may be identified from a non-RedCap UE by the gNodeB during Msg3 transmission, the request for Msg3 PUSCH repetition may be indicated by a RedCap or non-RedCap UE by using one or combination of approaches described above for identification between non-RedCap UEs that request Msg3 PUSCH repetition and non-RedCap UEs that do not, e.g., as in examples in FIGS. 2 and 3.

In another embodiment, if identification of RedCap UEs via Msg3 transmission is realized via different Msg3 PUSCH resources, a RedCap UE may only be identified from a non-RedCap UE during Msg3 transmission only when the Msg3 resources are not allocated with repetitions.

If further identification of RedCap UEs on their support of maximum number of Rx branches or maximum number of DL MIMO layers is supported during Msg1 transmission, one or combination of the above approaches can be straightforwardly extended to realize further partitioning of PRACH preambles and/or PRACH occasions and/or initial UL BWP.

### Systems and Implementations

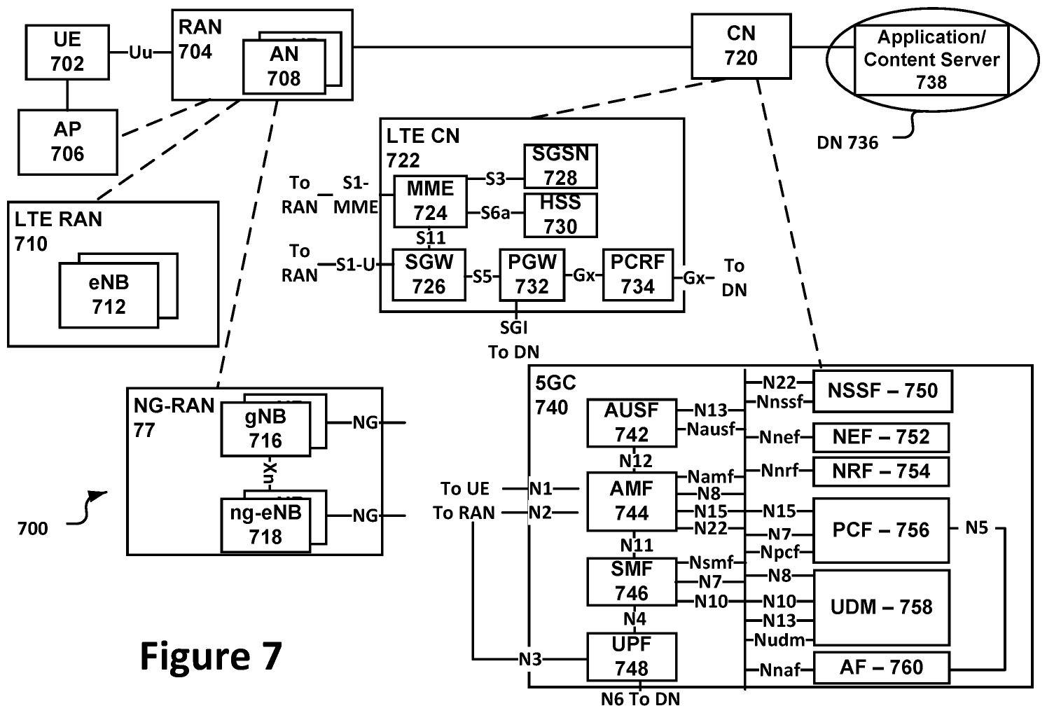

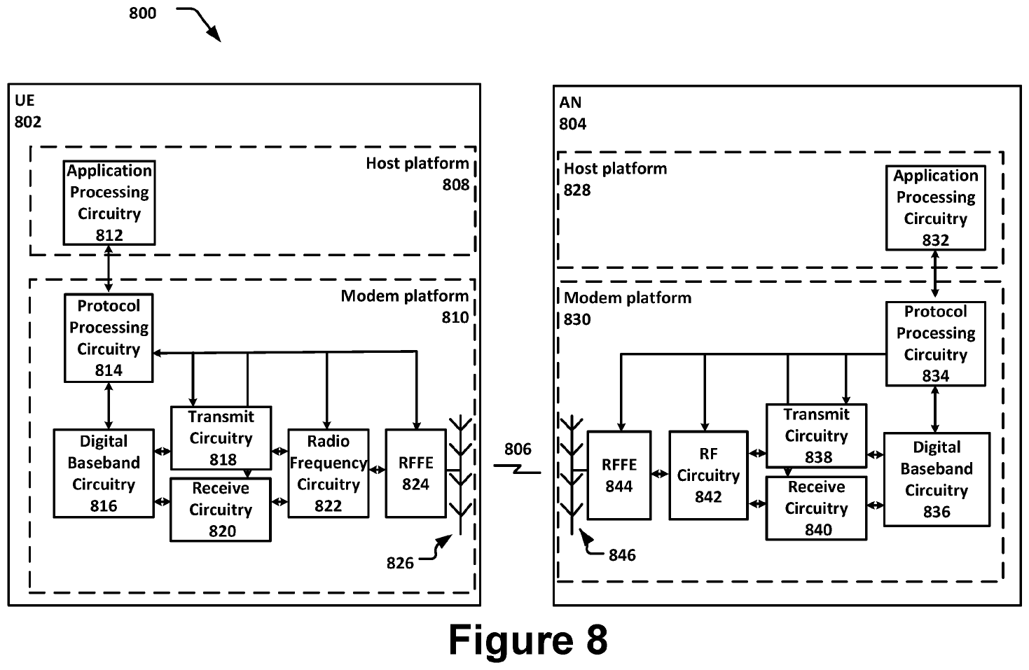

FIGS. 7-8 illustrate various systems, devices, and components that may implement aspects of disclosed embodiments.

FIG. 7 illustrates a network 700 in accordance with various embodiments. The network 700 may operate in a manner consistent with 3GPP technical specifications for LTE or 5G/NR systems. However, the example embodiments are not limited in this regard and the described embodiments may apply to other networks that benefit from the principles described herein, such as future 3GPP systems, or the like.

The network 700 may include a UE 702, which may include any mobile or non-mobile computing device designed to communicate with a RAN 704 via an over-the-air connection. The UE 702 may be communicatively coupled with the RAN 704 by a Uu interface. The UE 702 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

In some embodiments, the network 700 may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc.

In some embodiments, the UE 702 may additionally communicate with an AP 706 via an over-the-air connection. The AP 706 may manage a WLAN connection, which may serve to offload some/all network traffic from the RAN 704. The connection between the UE 702 and the AP 706 may be consistent with any IEEE 802.11 protocol, wherein the AP 706 could be a wireless fidelity (Wi-Fi®) router. In some embodiments, the UE 702, RAN 704, and AP 706 may utilize cellular-WLAN aggregation (for example, LWA/LWIP). Cellular-WLAN aggregation may involve the UE 702 being configured by the RAN 704 to utilize both cellular radio resources and

WLAN resources.

The RAN 704 may include one or more access nodes, for example, AN 708. AN 708 may terminate air-interface protocols for the UE 702 by providing access stratum protocols including RRC, PDCP, RLC, MAC, and LI protocols. In this manner, the AN 708 may enable data/voice connectivity between CN 720 and the UE 702. In some embodiments, the AN 708 may be implemented in a discrete device or as one or more software entities running on server computers as part of, for example, a virtual network, which may be referred to as a CRAN or virtual baseband unit pool. The AN 708 be referred to as a BS, gNB, RAN node, eNB, ng-eNB, NodeB, RSU, TRxP, TRP, etc. The AN 708 may be a macrocell base station or a low power base station for providing femtocells, picocells or other like cells having smaller coverage areas, smaller user capacity, or higher bandwidth compared to macrocells.

In embodiments in which the RAN 704 includes a plurality of ANs, they may be coupled with one another via an X2 interface (if the RAN 704 is an LTE RAN) or an Xn interface (if the RAN 704 is a 5G RAN). The X2/Xn interfaces, which may be separated into control/user plane interfaces in some embodiments, may allow the ANs to communicate information related to handovers, data/context transfers, mobility, load management, interference coordination, etc.

The ANs of the RAN 704 may each manage one or more cells, cell groups, component carriers, etc. to provide the UE 702 with an air interface for network access. The UE 702 may be simultaneously connected with a plurality of cells provided by the same or different ANs of the RAN 704. For example, the UE 702 and RAN 704 may use carrier aggregation to allow the UE 702 to connect with a plurality of component carriers, each corresponding to a Pcell or Scell. In dual connectivity scenarios, a first AN may be a master node that provides an MCG and a second AN may be secondary node that provides an SCG. The first/second ANs may be any combination of eNB, gNB, ng-eNB, etc.

The RAN 704 may provide the air interface over a licensed spectrum or an unlicensed spectrum. To operate in the unlicensed spectrum, the nodes may use LAA, eLAA, and/or feLAA mechanisms based on CA technology with PCells/Scells. Prior to accessing the unlicensed spectrum, the nodes may perform medium/carrier-sensing operations based on, for example, a listen-before-talk (LBT) protocol.

In V2X scenarios the UE 702 or AN 708 may be or act as a RSU, which may refer to any transportation infrastructure entity used for V2X communications. An RSU may be implemented in or by a suitable AN or a stationary (or relatively stationary) UE. An RSU implemented in or by: a UE may be referred to as a “UE-type RSU”; an eNB may be referred to as an “eNB-type RSU”; a gNB may be referred to as a “gNB-type RSU”; and the like. In one example, an RSU is a computing device coupled with radio frequency circuitry located on a roadside that provides connectivity support to passing vehicle UEs. The RSU may also include internal data storage circuitry to store intersection map geometry, traffic statistics, media, as well as applications/software to sense and control ongoing vehicular and pedestrian traffic. The RSU may provide very low latency communications required for high speed events, such as crash avoidance, traffic warnings, and the like. Additionally or alternatively, the RSU may provide other cellular/WLAN communications services. The components of the RSU may be packaged in a weatherproof enclosure suitable for outdoor installation, and may include a network interface controller to provide a wired connection (e.g., Ethernet) to a traffic signal controller or a backhaul network.

In some embodiments, the RAN 704 may be an LTE RAN 710 with eNBs, for example, eNB 712. The LTE RAN 710 may provide an LTE air interface with the following characteristics: SCS of 15 kHz; CP-OFDM waveform for DL and SC-FDMA waveform for UL; turbo codes for data and TBCC for control; etc. The LTE air interface may rely on CSI-RS for CSI acquisition and beam management; PDSCH/PDCCH DMRS for PDSCH/PDCCH demodulation; and CRS for cell search and initial acquisition, channel quality measurements, and channel estimation for coherent demodulation/detection at the UE. The LTE air interface may operating on sub-6 GHz bands.

In some embodiments, the RAN 704 may be an NG-RAN 714 with gNBs, for example, gNB 716, or ng-eNBs, for example, ng-eNB 718. The gNB 716 may connect with 5G-enabled UEs using a 5G NR interface. The gNB 716 may connect with a 5G core through an NG interface, which may include an N2 interface or an N3 interface. The ng-eNB 718 may also connect with the 5G core through an NG interface, but may connect with a UE via an LTE air interface. The gNB 716 and the ng-eNB 718 may connect with each other over an Xn interface.

In some embodiments, the NG interface may be split into two parts, an NG user plane (NG-U) interface, which carries traffic data between the nodes of the NG-RAN 714 and a UPF 748 (e.g., N3 interface), and an NG control plane (NG-C) interface, which is a signaling interface between the nodes of the NG-RAN 714 and an AMF 744 (e.g., N2 interface).

The NG-RAN 714 may provide a 5G-NR air interface with the following characteristics: variable SCS; CP-OFDM for DL, CP-OFDM and DFT-s-OFDM for UL; polar, repetition, simplex, and Reed-Muller codes for control and LDPC for data. The 5G-NR air interface may rely on CSI-RS, PDSCH/PDCCH DMRS similar to the LTE air interface. The 5G-NR air interface may not use a CRS, but may use PBCH DMRS for PBCH demodulation; PTRS for phase tracking for PDSCH; and tracking reference signal for time tracking. The 5G-NR air interface may operating on FR1 bands that include sub-6 GHz bands or FR2 bands that include bands from 24.25 GHz to 52.6 GHz. The 5G-NR air interface may include an SSB that is an area of a downlink resource grid that includes PSS/SSS/PBCH.

In some embodiments, the 5G-NR air interface may utilize BWPs for various purposes. For example, BWP can be used for dynamic adaptation of the SCS. For example, the UE 702 can be configured with multiple BWPs where each BWP configuration has a different SCS. When a BWP change is indicated to the UE 702, the SCS of the transmission is changed as well. Another use case example of BWP is related to power saving. In particular, multiple BWPs can be configured for the UE 702 with different amount of frequency resources (for example, PRBs) to support data transmission under different traffic loading scenarios. A BWP containing a smaller number of PRBs can be used for data transmission with small traffic load while allowing power saving at the UE 702 and in some cases at the gNB 716. A BWP containing a larger number of PRBs can be used for scenarios with higher traffic load.

The RAN 704 is communicatively coupled to CN 720 that includes network elements to provide various functions to support data and telecommunications services to customers/subscribers (for example, users of UE 702). The components of the CN 720 may be implemented in one physical node or separate physical nodes. In some embodiments, NFV may be utilized to virtualize any or all of the functions provided by the network elements of the CN 720 onto physical compute/storage resources in servers, switches, etc. A logical instantiation of the CN 720 may be referred to as a network slice, and a logical instantiation of a portion of the CN 720 may be referred to as a network sub-slice.

In some embodiments, the CN 720 may be an LTE CN 722, which may also be referred to as an EPC. The LTE CN 722 may include MME 724, SGW 726, SGSN 728, HSS 730, PGW 732, and PCRF 734 coupled with one another over interfaces (or “reference points”) as shown. Functions of the elements of the LTE CN 722 may be briefly introduced as follows.

The MME 724 may implement mobility management functions to track a current location of the UE 702 to facilitate paging, bearer activation/deactivation, handovers, gateway selection, authentication, etc.

The SGW 726 may terminate an SI interface toward the RAN and route data packets between the RAN and the LTE CN 722. The SGW 726 may be a local mobility anchor point for inter-RAN node handovers and also may provide an anchor for inter-3GPP mobility. Other responsibilities may include lawful intercept, charging, and some policy enforcement.

The SGSN 728 may track a location of the UE 702 and perform security functions and access control. In addition, the SGSN 728 may perform inter-EPC node signaling for mobility between different RAT networks; PDN and S-GW selection as specified by MME 724; MME selection for handovers; etc. The S3 reference point between the MME 724 and the SGSN 728 may enable user and bearer information exchange for inter-3GPP access network mobility in idle/active states.

The HSS 730 may include a database for network users, including subscription-related information to support the network entities' handling of communication sessions. The HSS 730 can provide support for routing/roaming, authentication, authorization, naming/addressing resolution, location dependencies, etc. An S6a reference point between the HSS 730 and the MME 724 may enable transfer of subscription and authentication data for authenticating/authorizing user access to the LTE CN 720.

The PGW 732 may terminate an SGi interface toward a data network (DN) 736 that may include an application/content server 738. The PGW 732 may route data packets between the LTE CN 722 and the data network 736. The PGW 732 may be coupled with the SGW 726 by an S5 reference point to facilitate user plane tunneling and tunnel management. The PGW 732 may further include a node for policy enforcement and charging data collection (for example, PCEF). Additionally, the SGi reference point between the PGW 732 and the data network 736 may be an operator external public, a private PDN, or an intra-operator packet data network, for example, for provision of IMS services. The PGW 732 may be coupled with a PCRF 734 via a Gx reference point.

The PCRF 734 is the policy and charging control element of the LTE CN 722. The PCRF 734 may be communicatively coupled to the app/content server 738 to determine appropriate QoS and charging parameters for service flows. The PCRF 732 may provision associated rules into a PCEF (via Gx reference point) with appropriate TFT and QCI.

In some embodiments, the CN 720 may be a 5GC 740. The 5GC 740 may include an AUSF 742, AMF 744, SMF 746, UPF 748, NSSF 750, NEF 752, NRF 754, PCF 756, UDM 758, and AF 760 coupled with one another over interfaces (or “reference points”) as shown. Functions of the elements of the 5GC 740 may be briefly introduced as follows.

The AUSF 742 may store data for authentication of UE 702 and handle authentication-related functionality. The AUSF 742 may facilitate a common authentication framework for various access types. In addition to communicating with other elements of the 5GC 740 over reference points as shown, the AUSF 742 may exhibit an Nausf service-based interface.

The AMF 744 may allow other functions of the 5GC 740 to communicate with the UE 702 and the RAN 704 and to subscribe to notifications about mobility events with respect to the UE 702. The AMF 744 may be responsible for registration management (for example, for registering UE 702), connection management, reachability management, mobility management, lawful interception of AMF-related events, and access authentication and authorization. The AMF 744 may provide transport for SM messages between the UE 702 and the SMF 746, and act as a transparent proxy for routing SM messages. AMF 744 may also provide transport for SMS messages between UE 702 and an SMSF. AMF 744 may interact with the AUSF 742 and the UE 702 to perform various security anchor and context management functions. Furthermore, AMF 744 may be a termination point of a RAN CP interface, which may include or be an N2 reference point between the RAN 704 and the AMF 744; and the AMF 744 may be a termination point of NAS (N1) signaling, and perform NAS ciphering and integrity protection. AMF 744 may also support NAS signaling with the UE 702 over an N3 IWF interface.

The SMF 746 may be responsible for SM (for example, session establishment, tunnel management between UPF 748 and AN 708); UE IP address allocation and management (including optional authorization); selection and control of UP function; configuring traffic steering at UPF 748 to route traffic to proper destination; termination of interfaces toward policy control functions; controlling part of policy enforcement, charging, and QoS; lawful intercept (for SM events and interface to LI system); termination of SM parts of NAS messages; downlink data notification; initiating AN specific SM information, sent via AMF 744 over N2 to AN 708; and determining SSC mode of a session. SM may refer to management of a PDU session, and a PDU session or “session” may refer to a PDU connectivity service that provides or enables the exchange of PDUs between the UE 702 and the data network 736.

The UPF 748 may act as an anchor point for intra-RAT and inter-RAT mobility, an external PDU session point of interconnect to data network 736, and a branching point to support multi-homed PDU session. The UPF 748 may also perform packet routing and forwarding, perform packet inspection, enforce the user plane part of policy rules, lawfully intercept packets (UP collection), perform traffic usage reporting, perform QoS handling for a user plane (e.g., packet filtering, gating, UL/DL rate enforcement), perform uplink traffic verification (e.g., SDF-to-QoS flow mapping), transport level packet marking in the uplink and downlink, and perform downlink packet buffering and downlink data notification triggering. UPF 748 may include an uplink classifier to support routing traffic flows to a data network.

The NSSF 750 may select a set of network slice instances serving the UE 702. The NSSF 750 may also determine allowed NSSAI and the mapping to the subscribed S-NSSAIs, if needed. The NSSF 750 may also determine the AMF set to be used to serve the UE 702, or a list of candidate AMFs based on a suitable configuration and possibly by querying the NRF 754. The selection of a set of network slice instances for the UE 702 may be triggered by the AMF 744 with which the UE 702 is registered by interacting with the NSSF 750, which may lead to a change of AMF. The NSSF 750 may interact with the AMF 744 via an N22 reference point; and may communicate with another NSSF in a visited network via an N31 reference point (not shown). Additionally, the NSSF 750 may exhibit an Nnssf service-based interface.

The NEF 752 may securely expose services and capabilities provided by 3GPP network functions for third party, internal exposure/re-exposure, AFs (e.g., AF 760), edge computing or fog computing systems, etc. In such embodiments, the NEF 752 may authenticate, authorize, or throttle the AFs. NEF 752 may also translate information exchanged with the AF 760 and information exchanged with internal network functions. For example, the NEF 752 may translate between an AF-Service-Identifier and an internal 5GC information. NEF 752 may also receive information from other NFs based on exposed capabilities of other NFs. This information may be stored at the NEF 752 as structured data, or at a data storage NF using standardized interfaces. The stored information can then be re-exposed by the NEF 752 to other NFs and AFs, or used for other purposes such as analytics. Additionally, the NEF 752 may exhibit an Nnef service-based interface.

The NRF 754 may support service discovery functions, receive NF discovery requests from NF instances, and provide the information of the discovered NF instances to the NF instances. NRF 754 also maintains information of available NF instances and their supported services. As used herein, the terms “instantiate,” “instantiation,” and the like may refer to the creation of an instance, and an “instance” may refer to a concrete occurrence of an object, which may occur, for example, during execution of program code. Additionally, the NRF 754 may exhibit the Nnrf service-based interface.

The PCF 756 may provide policy rules to control plane functions to enforce them, and may also support unified policy framework to govern network behavior. The PCF 756 may also implement a front end to access subscription information relevant for policy decisions in a UDR of the UDM 758. In addition to communicating with functions over reference points as shown, the PCF 756 exhibit an Npcf service-based interface.

The UDM 758 may handle subscription-related information to support the network entities' handling of communication sessions, and may store subscription data of UE 702. For example, subscription data may be communicated via an N8 reference point between the UDM 758 and the AMF 744. The UDM 758 may include two parts, an application front end and a UDR. The UDR may store subscription data and policy data for the UDM 758 and the PCF 756, and/or structured data for exposure and application data (including PFDs for application detection, application request information for multiple UEs 702) for the NEF 752. The Nudr service-based interface may be exhibited by the UDR 221 to allow the UDM 758, PCF 756, and NEF 752 to access a particular set of the stored data, as well as to read, update (e.g., add, modify), delete, and subscribe to notification of relevant data changes in the UDR. The UDM may include a UDM-FE, which is in charge of processing credentials, location management, subscription management and so on. Several different front ends may serve the same user in different transactions. The UDM-FE accesses subscription information stored in the UDR and performs authentication credential processing, user identification handling, access authorization, registration/mobility management, and subscription management. In addition to communicating with other NFs over reference points as shown, the UDM 758 may exhibit the Nudm service-based interface.

The AF 760 may provide application influence on traffic routing, provide access to NEF, and interact with the policy framework for policy control.

In some embodiments, the 5GC 740 may enable edge computing by selecting operator/3rd party services to be geographically close to a point that the UE 702 is attached to the network. This may reduce latency and load on the network. To provide edge-computing implementations, the 5GC 740 may select a UPF 748 close to the UE 702 and execute traffic steering from the UPF 748 to data network 736 via the N6 interface. This may be based on the UE subscription data, UE location, and information provided by the AF 760. In this way, the AF 760 may influence UPF (re)selection and traffic routing. Based on operator deployment, when AF 760 is considered to be a trusted entity, the network operator may permit AF 760 to interact directly with relevant NFs. Additionally, the AF 760 may exhibit an Naf service-based interface.

The data network 736 may represent various network operator services, Internet access, or third party services that may be provided by one or more servers including, for example, application/content server 738.

FIG. 8 schematically illustrates a wireless network 800 in accordance with various embodiments. The wireless network 800 may include a UE 802 in wireless communication with an AN 804. The UE 802 and AN 804 may be similar to, and substantially interchangeable with, like-named components described elsewhere herein.

The UE 802 may be communicatively coupled with the AN 804 via connection 806. The connection 806 is illustrated as an air interface to enable communicative coupling, and can be consistent with cellular communications protocols such as an LTE protocol or a 5G NR protocol operating at mmWave or sub-6 GHZ frequencies.

The UE 802 may include a host platform 808 coupled with a modem platform 810. The host platform 808 may include application processing circuitry 812, which may be coupled with protocol processing circuitry 814 of the modem platform 810. The application processing circuitry 812 may run various applications for the UE 802 that source/sink application data. The application processing circuitry 812 may further implement one or more layer operations to transmit/receive application data to/from a data network. These layer operations may include transport (for example UDP) and Internet (for example, IP) operations

The protocol processing circuitry 814 may implement one or more of layer operations to facilitate transmission or reception of data over the connection 806. The layer operations implemented by the protocol processing circuitry 814 may include, for example, MAC, RLC, PDCP, RRC and NAS operations.

The modem platform 810 may further include digital baseband circuitry 816 that may implement one or more layer operations that are “below” layer operations performed by the protocol processing circuitry 814 in a network protocol stack. These operations may include, for example, PHY operations including one or more of HARQ-ACK functions, scrambling/descrambling, encoding/decoding, layer mapping/de-mapping, modulation symbol mapping, received symbol/bit metric determination, multi-antenna port precoding/decoding, which may include one or more of space-time, space-frequency or spatial coding, reference signal generation/detection, preamble sequence generation and/or decoding, synchronization sequence generation/detection, control channel signal blind decoding, and other related functions.

The modem platform 810 may further include transmit circuitry 818, receive circuitry 820, RF circuitry 822, and RF front end (RFFE) 824, which may include or connect to one or more antenna panels 826. Briefly, the transmit circuitry 818 may include a digital-to-analog converter, mixer, intermediate frequency (IF) components, etc.; the receive circuitry 820 may include an analog-to-digital converter, mixer, IF components, etc.; the RF circuitry 822 may include a low-noise amplifier, a power amplifier, power tracking components, etc.; RFFE 824 may include filters (for example, surface/bulk acoustic wave filters), switches, antenna tuners, beamforming components (for example, phase-array antenna components), etc. The selection and arrangement of the components of the transmit circuitry 818, receive circuitry 820, RF circuitry 822, RFFE 824, and antenna panels 826 (referred generically as “transmit/receive components”) may be specific to details of a specific implementation such as, for example, whether communication is TDM or FDM, in mmWave or sub-6 gHz frequencies, etc. In some embodiments, the transmit/receive components may be arranged in multiple parallel transmit/receive chains, may be disposed in the same or different chips/modules, etc.

In some embodiments, the protocol processing circuitry 814 may include one or more instances of control circuitry (not shown) to provide control functions for the transmit/receive components.

A UE reception may be established by and via the antenna panels 826, RFFE 824, RF circuitry 822, receive circuitry 820, digital baseband circuitry 816, and protocol processing circuitry 814. In some embodiments, the antenna panels 826 may receive a transmission from the AN 804 by receive-beamforming signals received by a plurality of antennas/antenna elements of the one or more antenna panels 826.

A UE transmission may be established by and via the protocol processing circuitry 814, digital baseband circuitry 816, transmit circuitry 818, RF circuitry 822, RFFE 824, and antenna panels 826. In some embodiments, the transmit components of the UE 804 may apply a spatial filter to the data to be transmitted to form a transmit beam emitted by the antenna elements of the antenna panels 826.

Similar to the UE 802, the AN 804 may include a host platform 828 coupled with a modem platform 830. The host platform 828 may include application processing circuitry 832 coupled with protocol processing circuitry 834 of the modem platform 830. The modem platform may further include digital baseband circuitry 836, transmit circuitry 838, receive circuitry 840, RF circuitry 842, RFFE circuitry 844, and antenna panels 846. The components of the AN 804 may be similar to and substantially interchangeable with like-named components of the UE 802. In addition to performing data transmission/reception as described above, the components of the AN 808 may perform various logical functions that include, for example, RNC functions such as radio bearer management, uplink and downlink dynamic radio resource management, and data packet scheduling.

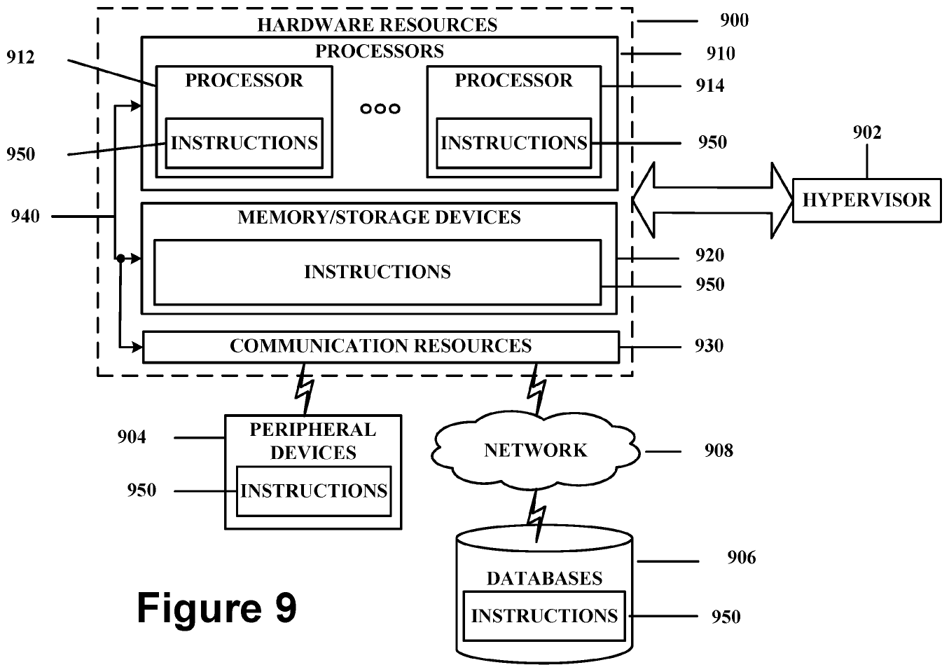

FIG. 9 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 9 shows a diagrammatic representation of hardware resources 900 including one or more processors (or processor cores) 910, one or more memory/storage devices 920, and one or more communication resources 930, each of which may be communicatively coupled via a bus 940 or other interface circuitry. For embodiments where node virtualization (e.g., NFV) is utilized, a hypervisor 902 may be executed to provide an execution environment for one or more network slices/sub-slices to utilize the hardware resources 900.

The processors 910 may include, for example, a processor 912 and a processor 914. The processors 910 may be, for example, a central processing unit (CPU), a reduced instruction set computing (RISC) processor, a complex instruction set computing (CISC) processor, a graphics processing unit (GPU), a DSP such as a baseband processor, an ASIC, an FPGA, a radio-frequency integrated circuit (RFIC), another processor (including those discussed herein), or any suitable combination thereof.

The memory/storage devices 920 may include main memory, disk storage, or any suitable combination thereof. The memory/storage devices 920 may include, but are not limited to, any type of volatile, non-volatile, or semi-volatile memory such as dynamic random access memory (DRAM), static random access memory (SRAM), erasable programmable read-only memory (EPROM), electrically erasable programmable read-only memory (EEPROM), Flash memory, solid-state storage, etc.

The communication resources 930 may include interconnection or network interface controllers, components, or other suitable devices to communicate with one or more peripheral devices 904 or one or more databases 906 or other network elements via a network 908. For example, the communication resources 930 may include wired communication components (e.g., for coupling via USB, Ethernet, etc.), cellular communication components, NFC components, Bluetooth® (or Bluetooth® Low Energy) components, Wi-Fi® components, and other communication components.

Instructions 950 may comprise software, a program, an application, an applet, an app, or other executable code for causing at least any of the processors 910 to perform any one or more of the methodologies discussed herein. The instructions 950 may reside, completely or partially, within at least one of the processors 910 (e.g., within the processor's cache memory), the memory/storage devices 920, or any suitable combination thereof. Furthermore, any portion of the instructions 950 may be transferred to the hardware resources 900 from any combination of the peripheral devices 904 or the databases 906. Accordingly, the memory of processors 910, the memory/storage devices 920, the peripheral devices 904, and the databases 906 are examples of computer-readable and machine-readable media.

### Example Procedures

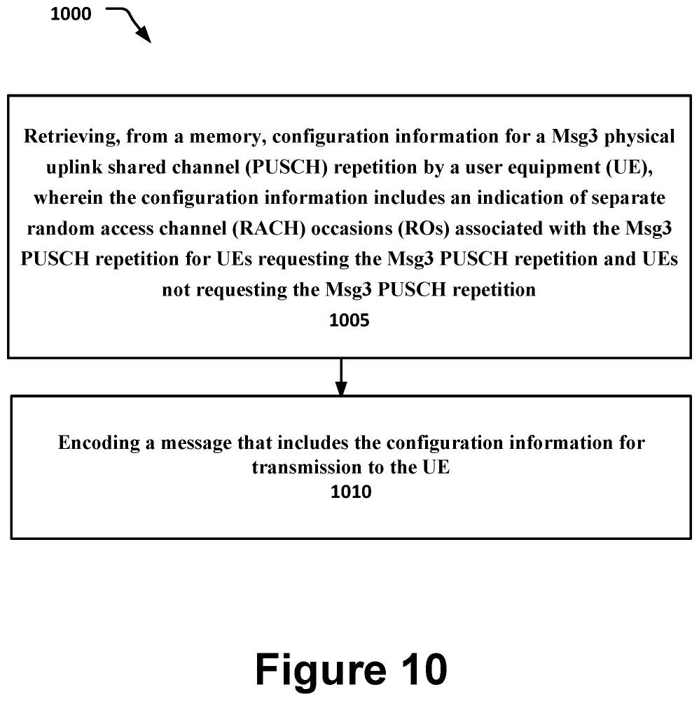

In some embodiments, the electronic device(s), network(s), system(s), chip(s) or component(s), or portions or implementations thereof, of FIGS. 7-9, or some other figure herein, may be configured to perform one or more processes, techniques, or methods as described herein, or portions thereof. One such process is depicted in FIG. 10. For example, process 1000 may include, at 1005, retrieving, from a memory, configuration information for a Msg3 physical uplink shared channel (PUSCH) repetition by a user equipment (UE), wherein the configuration information includes an indication of separate random access channel (RACH) occasions (ROs) associated with the Msg3 PUSCH repetition for UEs requesting the Msg3 PUSCH repetition and UEs not requesting the Msg3 PUSCH repetition. The process further includes, at 1010, encoding a message that includes the configuration information for transmission to the UE.

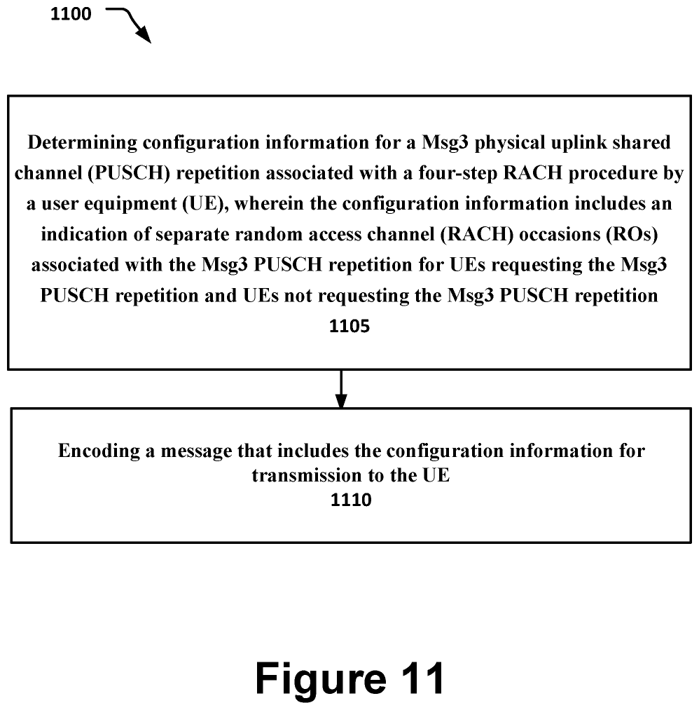

Another such process is illustrated in FIG. 11. In this example, the process 1100 includes, at 1105, determining configuration information for a Msg3 physical uplink shared channel (PUSCH) repetition associated with a four-step RACH procedure by a user equipment (UE), wherein the configuration information includes an indication of separate random access channel (RACH) occasions (ROs) associated with the Msg3 PUSCH repetition for UEs requesting the Msg3 PUSCH repetition and UEs not requesting the Msg3 PUSCH repetition. The process further includes, at 1110, encoding a message that includes the configuration information for transmission to the UE.

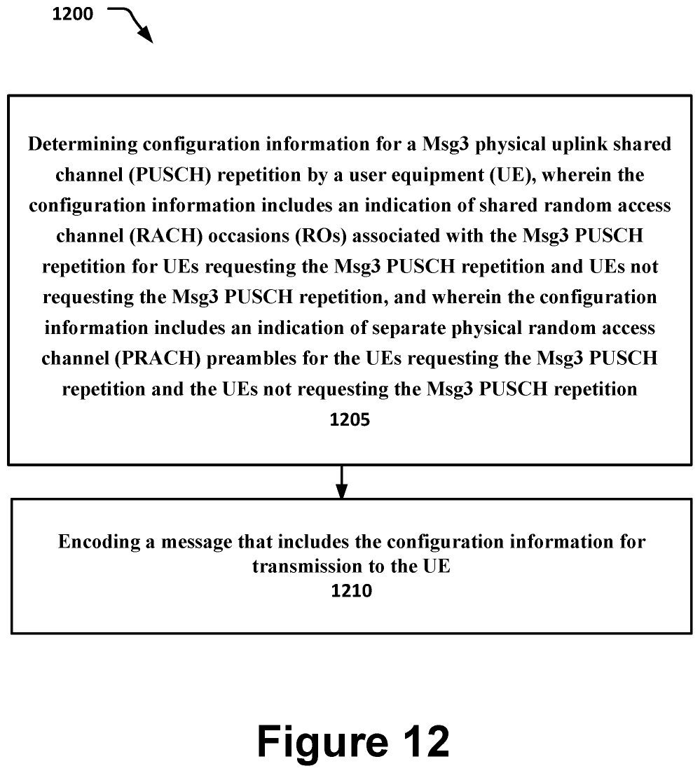

Another such process is illustrated in FIG. 12. In this example, the process 1200 includes, at 1205, determining configuration information for a Msg3 physical uplink shared channel (PUSCH) repetition by a user equipment (UE), wherein the configuration information includes an indication of shared random access channel (RACH) occasions (ROs) associated with the Msg3 PUSCH repetition for UEs requesting the Msg3 PUSCH repetition and UEs not requesting the Msg3 PUSCH repetition, and wherein the configuration information includes an indication of separate physical random access channel (PRACH) preambles associated with the shared RACH ROs for the UEs requesting the Msg3 PUSCH repetition and the UEs not requesting the Msg3 PUSCH repetition. The process further includes, at 1210, encoding a message that includes the configuration information for transmission to the UE.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### Examples

Example 1 may include a method of wireless communication for a fifth generation (5G) or new radio (NR) system, comprising:
configuring, by a gNodeB, separate physical random access channel (PRACH) preambles for request of Msg3 PUSCH repetition using 4-step RACH procedure.

Example 2 may include the method of example 1 or sme other example herein, wherein separate PRACH preambles can be in a shared PRACH occasion (RO) or separate ROs.

Example 3 may include the method of example 1 or some other example herein, wherein separate parameters for synchronization signal block (SSB) to RACH occasion (RO) association can be configured enhanced UEs who request for Msg3 PUSCH repetition and those that do not.

Example 4 may include the method of example 1 or some other example herein, wherein in case of separate ROs, different PRACH formats can be configured for UEs who request of Msg3 PUCSH repetition for 4-step RACH and those that do not.

Example 5 may include the method of example 1 or some other example herein, wherein for shared PRACH occasions between enhanced UEs requesting Msg3 PUSCH repetition and those that do not, a number of PRACH preambles can be separately provided for enhanced UEs requesting Msg3 PUCSH repetition for 4-step RACH.

Example 6 may include the method of example 1 or some other example herein, wherein in case of shared ROs, PRACH preambles for enhanced UEs for request of Msg3 PUSCH repetition may be allocated after the PRACH preambles allocated after CBRA 4-step RACH and/or 2-step RACH.

Example 7 may include the method of example 1 or some other example herein, wherein if separate PRACH occasions for CBRA 2-step RACH are configured from legacy 4-step RACH, the preambles used for request of Msg3 PUSCH repetition are mapped after CBRA 4-step RACH preambles associated with one SSB.

Example 8 may include the method of example 1 or some other example herein, wherein in case of shared PRACH occasions, PRACH preambles for request of Msg3 PUSCH repetition are allocated within the preambles for legacy CBRA 4-step RACH; wherein PRACH preambles for request of Msg3 PUSCH repetition are mapped after the these for legacy CBRA 4-step RACH procedure, but before these for legacy CBRA 2-step RACH procedure.

Example 9 may include the method of example 1 or some other example herein, wherein in case of shared PRACH occasions, PRACH preambles for request of Msg3 PUSCH repetition are allocated within the preambles for other purpose, e.g., from totalNumberOfRA-Preambles to 63 within a RO.

Example 10 may include the method of example 1 or some other example herein, wherein the preambles for request of Msg3 PUSCH repetition within these for other purpose are partitioned into multiple sets, where each set is associated with an SSB.

Example 11 may include the method of example 1 or some other example herein, wherein UE may request different number of repetitions for Msg3 PUSCH repetition.

Example 12 may include the method of example 1 or some other example herein, wherein when RACH based small data transmission (RA-SDT) is configured for RRC_INACTIVE UEs, and in case when shared ROs are used for RA-SDT, legacy RACH and request of Msg3 PUSCH repetition, the preambles for request of Msg3 PUSCH repetition can be allocated after PRACH preambles for 4-step RACH based RA-SDT within each set of PRACH preambles associated with the same SSB.

Example 13 may include the method of example 1 or some other example herein, wherein when shared PRACH occasion is configured for request of Msg3 PUSCH repetition and legacy 2-step and 4-step RACH, a subset of ROs associated with the same SS/PBCH block index, within an SSB-RO mapping cycle, can be shared.

Example 14 may include the method of example 1 or some other example herein, wherein the above embodiments can also apply to differentiate reduced capability (RedCap) UEs and non-RedCap UEs, wherein separate PRACH resources in case of shared ROs and separate ROs can be configured by higher layers to differentiate RedCap UEs and non-RedCap UEs.

Example 15 may include the method of example 1 or some other example herein, wherein in case of shared ROs between request of Msg3 PUSCH repetition for RedCap and non-RedCap UEs, PRACH preambles for enhanced non-RedCap UEs and RedCap UEs for request of Msg3 PUSCH repetition may be allocated after the preambles allocated for CBRA 4-step RACH and/or 2-step RACH.

Example 16 may include the method of example 1 or some other example herein, wherein in case of shared ROs between request of Msg3 PUSCH repetition for RedCap and non-RedCap UEs, if a RO is also shared with non-RedCap UEs not requesting Msg3 PUSCH repetition, then the RO is also shared with RedCap UEs not requesting Msg3 PUSCH repetition.

Example 17 may include the method of example 1 or some other example herein, wherein identification between RedCap and non-RedCap UEs may only be realized via separate PRACH occasions while identification between requesting Msg3 PUSCH repetitions or not for either RedCap or non-RedCap UEs respectively may be realized via partitioning of PRACH preambles.

Example 18 may include the method of example 1 or some other example herein, wherein when a RedCap UE may be provided with separate initial Uplink (UL) BandWidth Part (BWP) or separate PRACH occasions (ROs) from that for non-RedCap UEs and when ROs are shared between RedCap UEs that request Msg3 PUSCH repetition and RedCap UEs that do not, PRACH preambles may be partitioned for the identification of RedCap UEs requesting Msg3 PUSCH repetition using one or a combination of approaches described above for identification between non-RedCap UEs that request Msg3 PUSCH repetition and non-RedCap UEs that do not.

Example 19 may include the method of example 1 or some other example herein, wherein when a RedCap UE may be identified from a non-RedCap UE by the gNodeB during Msg3 transmission, the request for Msg3 PUSCH repetition may be indicated by a RedCap or non-RedCap UE by using one or combination of approaches described above for identification between non-RedCap UEs that request Msg3 PUSCH repetition and non-RedCap UEs that do not

Example 20 may include the method of example 1 or some other example herein, wherein if identification of RedCap UEs via Msg3 transmission is realized via different Msg3 PUSCH resources, a RedCap UE may only be identified from a non-RedCap UE during Msg3 transmission only when the Msg3 resources are not allocated with repetitions.

Example 21 includes a method of a next-generation NodeB (gNB) comprising:
determining configuration information that includes an indication of separate physical random access channel (PRACH) preambles for a request of a Msg3 physical uplink shared channel (PUSCH) repetition using a four-step RACH procedure; and
encoding a message including the configuration information for transmission to a user equipment (UE).

Example 22 includes the method of example 21 or some other example herein, wherein the separate PRACH preambles are in a common shared RACH occasion (RO) or in separate ROs.

Example 23 includes the method of example 21 or some other example herein, wherein the configuration information further includes an indication of a parameter for synchronization signal block (SSB) to RACH occasion (RO) association.

Example 24 includes the method of example 21 or some other example herein, wherein the configuration information includes an indication of a plurality of PRACH formats.

Example 25 includes the method of example 21 or some other example herein, wherein the configuration information includes an indication of a number of PRACH preambles.

Example 26 includes the method of example 21 or some other example herein, wherein the PRACH preambles are to be allocated after one or more PRACH preambles associated with CBRA 4-step RACH and/or 2-step RACH.

Example 27 includes the method of example 21 or some other example herein, wherein the PRACH preambles are to be mapped after CBRA 4-step RACH preambles associated with one SSB.

Example 28 includes the method of example 21 or some other example herein, wherein the PRACH preambles are to be allocated within preambles for legacy CBRA 4-step RACH.

Example 29 includes the method of example 21 or some other example herein, wherein the PRACH preambles are to be allocated from a total number of preambles within an RO.

Example 30 includes the method of example 21 or some other example herein, wherein the PRACH preambles are to be partitioned into multiple sets, where each set is associated with an SSB.

Example 31 includes a method of a user equipment (UE) comprising:
receiving, from a next-generation NodeB (gNB), configuration information that includes an indication of separate physical random access channel (PRACH) preambles for a request of a Msg3 physical uplink shared channel (PUSCH) repetition using a four-step RACH procedure;
and encoding a Msg3 PUSCH repetition message for transmission based on the configuration information.

Example 32 includes the method of example 31 or some other example herein, wherein the separate PRACH preambles are in a common shared RACH occasion (RO) or in separate ROs.

Example 33 includes the method of example 31 or some other example herein, wherein the configuration information further includes an indication of a parameter for synchronization signal block (SSB) to RACH occasion (RO) association.

Example 34 includes the method of example 31 or some other example herein, wherein the configuration information includes an indication of a plurality of PRACH formats.

Example 35 includes the method of example 31 or some other example herein, wherein the configuration information includes an indication of a number of PRACH preambles.

Example 36 includes the method of example 31 or some other example herein, wherein the PRACH preambles are to be allocated after one or more PRACH preambles associated with CBRA 4-step RACH and/or 2-step RACH.

Example 37 includes the method of example 31 or some other example herein, wherein the PRACH preambles are to be mapped after CBRA 4-step RACH preambles associated with one SSB.

Example 38 includes the method of example 31 or some other example herein, wherein the PRACH preambles are to be allocated within preambles for legacy CBRA 4-step RACH.

Example 39 includes the method of example 31 or some other example herein, wherein the PRACH preambles are to be allocated from a total number of preambles within an RO.

Example 40 includes the method of example 31 or some other example herein, wherein the PRACH preambles are to be partitioned into multiple sets, where each set is associated with an SSB.

Example X1 includes an apparatus comprising:
memory to store configuration information for a Msg3 physical uplink shared channel (PUSCH) repetition by a user equipment (UE); and
processing circuitry, coupled with the memory, to:
   retrieve the configuration information from memory, wherein the configuration information includes an indication of separate random access channel (RACH) occasions (ROs) associated with the Msg3 PUSCH repetition for UEs requesting the Msg3 PUSCH repetition and UEs not requesting the Msg3 PUSCH repetition; and
   encode a message that includes the configuration information for transmission to the UE.

Example X2 includes the apparatus of example X1 or some other example herein, wherein the Msg3 PUSCH repetition is associated with a four-step RACH procedure.

Example X3 includes the apparatus of example X1 or some other example herein, wherein the configuration information includes an indication of: a PRACH root sequence index, a zero-correlation zone configuration, a restricted set configuration, a total number of preambles available for a request of a Msg3 PUSCH repetition, a Msg1 frequency division multiplexing (FDM), or a Msg1 frequency start.

Example X4 includes the apparatus of example X1 or some other example herein, wherein the configuration includes an indication of a parameter for an association between a synchronization signal block (SSB) and an RO.

Example X5 includes the apparatus of example X1 or some other example herein, wherein the configuration information includes an indication of a plurality of PRACH formats.

Example X6 includes the apparatus of example X1 or some other example herein, wherein the configuration information is to indicate an initial uplink (UL) bandwidth part (BWP) for a reduced capability (RedCap) UE.

Example X7 includes the apparatus of example X6 or some other example herein, wherein the configuration information includes a PRACH preamble partitioning for the RedCap UE.

Example X8 includes the apparatus of any of examples X1-X7 or some other example herein, wherein the apparatus includes a next-generation NodeB (gNB) or portion thereof.

Example X9 includes one or more computer-readable media storing instructions that, when executed by one or more processors, cause a next-generation NodeB (gNB) to: determine configuration information for a Msg3 physical uplink shared channel (PUSCH) repetition associated with a four-step RACH procedure by a user equipment (UE), wherein the configuration information includes an indication of separate random access channel (RACH) occasions (ROs) associated with the Msg3 PUSCH repetition for UEs requesting the Msg3 PUSCH repetition and UEs not requesting the Msg3 PUSCH repetition; and encode a message that includes the configuration information for transmission to the UE.

Example X10 includes the one or more computer-readable media of example X9 or some other example herein, wherein the configuration information includes an indication of: a PRACH root sequence index, a zero-correlation zone configuration, a restricted set configuration, a total number of preambles available for a request of a Msg3 PUSCH repetition, a Msg1 frequency division multiplexing (FDM), or a Msg1 frequency start.

Example X11 includes the one or more computer-readable media of example X9 or some other example herein, wherein the configuration includes an indication of a parameter for an association between a synchronization signal block (SSB) and an RO.

Example X12 includes the one or more computer-readable media of example X9 or some other example herein, wherein the configuration information includes an indication of a plurality of PRACH formats.

Example X13 includes the one or more computer-readable media of example X9 or some other example herein, wherein the configuration information is to indicate an initial uplink (UL) bandwidth part (BWP) for a reduced capability (RedCap) UE.

Example X14 includes the one or more computer-readable media of example X13 or some other example herein, wherein the configuration information includes a PRACH preamble partitioning for the RedCap UE.

Example X15 includes one or more computer-readable media storing instructions that, when executed by one or more processors, cause a next-generation NodeB (gNB) to:
determine configuration information for a Msg3 physical uplink shared channel (PUSCH) repetition by a user equipment (UE), wherein the configuration information includes an indication of shared random access channel (RACH) occasions (ROs) associated with the Msg3 PUSCH repetition for UEs requesting the Msg3 PUSCH repetition and UEs not requesting the Msg3 PUSCH repetition, and wherein the configuration information includes an indication of separate physical random access channel (PRACH) preambles associated with the shared RACH ROs for the UEs requesting the Msg3 PUSCH repetition and the UEs not requesting the Msg3 PUSCH repetition; and
encode a message that includes the configuration information for transmission to the UE.

Example X16 includes the one or more computer-readable media of example X15 or some other example herein, wherein the configuration information includes an indication of a total number of contention-based random access (CBRA) preambles and a total number of contention-free random access (CFRA) preambles.

Example X17 includes the one or more computer-readable media of example X16 or some other example herein, wherein the PRACH preambles for the UEs requesting the Msg3 PUSCH repetition are allocated after the CBRA preambles.

Example X18 includes the one or more computer-readable media of example X16 or some other example herein, wherein the CBRA preambles are associated with a two-step RACH procedure or a four-step RACH procedure.

Example X19 includes the one or more computer-readable media of example X15 or some other example herein, wherein the configuration information includes an indication of a set of PRACH preambles associated with a synchronization signal block (SSB).

Example X20 includes the one or more computer-readable media of example X15 or some other example herein, wherein the configuration information is to indicate an initial uplink (UL) bandwidth part (BWP) for a reduced capability (RedCap) UE.

Example X21 includes the one or more computer-readable media of example X20 or some other example herein, wherein the configuration information includes a PRACH preamble partitioning for the RedCap UE.

Example Z01 may include an apparatus comprising means to perform one or more elements of a method described in or related to any of examples 1-X21, or any other method or process described herein.

Example Z02 may include one or more non-transitory computer-readable media comprising instructions to cause an electronic device, upon execution of the instructions by one or more processors of the electronic device, to perform one or more elements of a method described in or related to any of examples 1-X21, or any other method or process described herein.

Example Z03 may include an apparatus comprising logic, modules, or circuitry to perform one or more elements of a method described in or related to any of examples 1-X21, or any other method or process described herein.

Example Z04 may include a method, technique, or process as described in or related to any of examples 1-X21, or portions or parts thereof.

Example Z05 may include an apparatus comprising: one or more processors and one or more computer-readable media comprising instructions that, when executed by the one or more processors, cause the one or more processors to perform the method, techniques, or process as described in or related to any of examples 1-X21, or portions thereof.

Example Z06 may include a signal as described in or related to any of examples 1-X21, or portions or parts thereof.

Example Z07 may include a datagram, packet, frame, segment, protocol data unit (PDU), or message as described in or related to any of examples 1-X21, or portions or parts thereof, or otherwise described in the present disclosure.

Example Z08 may include a signal encoded with data as described in or related to any of examples 1-X21, or portions or parts thereof, or otherwise described in the present disclosure.

Example Z09 may include a signal encoded with a datagram, packet, frame, segment, protocol data unit (PDU), or message as described in or related to any of examples 1-X21, or portions or parts thereof, or otherwise described in the present disclosure.

Example Z10 may include an electromagnetic signal carrying computer-readable instructions, wherein execution of the computer-readable instructions by one or more processors is to cause the one or more processors to perform the method, techniques, or process as described in or related to any of examples 1-X21, or portions thereof.

Example Z11 may include a computer program comprising instructions, wherein execution of the program by a processing element is to cause the processing element to carry out the method, techniques, or process as described in or related to any of examples 1-X21, or portions thereof.

Example Z12 may include a signal in a wireless network as shown and described herein.

Example Z13 may include a method of communicating in a wireless network as shown and described herein.

Example Z14 may include a system for providing wireless communication as shown and described herein.

Example Z15 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

### Abbreviations

Unless used differently herein, terms, definitions, and abbreviations may be consistent with terms, definitions, and abbreviations defined in 3GPP TR 21.905 v16.0.0 (2019-06). For the purposes of the present document, the following abbreviations may apply to the examples and embodiments discussed herein.

| | | |
|---|---|---|
| 3GPP Third Generation | AP Application | BRAS Broadband |
| Partnership | Protocol, Antenna | Remote Access |
| Project | Port, Access Point | Server |
| 4G Fourth | API Application | BSS Business |
| Generation | Programming Interface | Support System |
| 5G Fifth Generation | APN Access Point | BS Base Station |
| 5GC 5G Core network | Name | BSR Buffer Status |
| AC Application | ARP Allocation and | Report |
| Client | Retention Priority | BW Bandwidth |
| ACR Application | ARQ Automatic | BWP Bandwidth Part |
| Context Relocation | Repeat Request | C-RNTI Cell |
| ACK | AS Access Stratum | Radio Network |
| Acknowledgement | ASP | Temporary |
| ACID | Application Service | Identity |
| Application | Provider | CA Carrier |
| Client Identification | ASN.1 Abstract Syntax | Aggregation, |
| AF Application | Notation One | Certification |
| Function | AUSF Authentication | Authority |
| AM Acknowledged | Server Function | CAPEX CAPital |
| Mode | AWGN Additive | EXpenditure |
| AMBRAggregate | White Gaussian | CBRA Contention |
| Maximum Bit Rate | Noise | Based Random |
| AMF Access and | BAP Backhaul | Access |
| Mobility | Adaptation Protocol | CC Component |
| Management | BCH Broadcast | Carrier, Country |
| Function | Channel | Code, Cryptographic |
| AN Access Network | BER Bit Error Ratio | Checksum |
| ANR Automatic | BFD Beam | CCA Clear Channel |
| Neighbour Relation | Failure Detection | Assessment |
| AOA Angle of | BLER Block Error Rate | CCE Control Channel |
| Arrival | BPSK Binary Phase | Element |
| CDM Content Delivery | Shift Keying | CCCH Common |
| Network | CoMP Coordinated | Control Channel |
| CDMA Code- | Multi-Point | CE Coverage |
| Division Multiple | CORESET Control | Enhancement |
| Access | Resource Set | Resource |
| CDR Charging Data | COTS Commercial Off- | Indicator |
| Request | The-Shelf | C-RNTI Cell |
| CDR Charging Data | CP Control Plane, | RNTI |
| Response | Cyclic Prefix, | CS Circuit Switched |
| CFRA Contention Free | Connection | CSCF call |
| Random Access | Point | session control function |
| CG Cell Group | CPD Connection | CSAR Cloud Service |
| CGF Charging | Point Descriptor | Archive |
| Gateway Function | CPE Customer | CSI Channel-State |
| CHF Charging | Premise | Information |
| Function | Equipment | CSI-IM CSI |
| CI Cell Identity | CPICHCommon Pilot | Interference |
| CID Cell-ID (e.g., | Channel | Measurement |
| positioning method) | CQI Channel Quality | CSI-RS CSI |
| CIM Common | Indicator | Reference Signal |
| Information Model | CPU CSI processing | CSI-RSRP CSI |
| CIR Carrier to | unit, Central | reference signal |
| Interference Ratio | Processing Unit | received power |
| CK Cipher Key | C/R | CSI-RSRQ CSI |
| CM Connection | Command/Response | reference signal |
| Management, | field bit | received quality |
| Conditional | CRAN Cloud Radio | CSI-SINR CSI |
| Mandatory | Access Network, | signal-to-noise and |
| CMAS Commercial | Cloud RAN | interference ratio |
| Mobile Alert Service | CRB Common | CSMA Carrier Sense |
| CMD Command | Resource Block | Multiple Access |
| CMS Cloud | CRC Cyclic | CSMA/CA CSMA |
| Management System | Redundancy Check | with collision |
| CO Conditional | CRI Channel-State | avoidance |
| Optional | Information Resource | CSS Common Search |
| CTS Clear-to-Send | Indicator, CSI-RS | Space, Cell- specific |
| CW Codeword | DSL Domain Specific | Search Space |
| CWS Contention | Language. Digital | CTF Charging |
| Window Size | Subscriber Line | Trigger Function |
| D2D Device-to- | DSLAM DSL | ECSP Edge |
| Device | Access Multiplexer | Computing Service |
| DC Dual | DwPTS | Provider |
| Connectivity, Direct | Downlink Pilot | EDN Edge |
| Current | Time Slot | Data Network |
| DCI Downlink | E-LAN Ethernet | EEC Edge |
| Control | Local Area Network | Enabler Client |
| Information | E2E End-to-End | EECID Edge |
| DF Deployment | EAS Edge | Enabler Client |
| Flavour | Application Server | Identification |
| DL Downlink | ECCA extended clear | EES Edge |
| DMTF Distributed | channel | Enabler Server |
| Management Task | assessment, | EESID Edge |
| Force | extended CCA | Enabler Server |
| DPDK Data Plane | ECCE Enhanced | Identification |
| Development Kit | Control Channel | EHE Edge |
| DM-RS, DMRS | Element, | Hosting Environment |
| Demodulation | Enhanced CCE | EGMF Exposure |
| Reference Signal | ED Energy | Governance |
| DN Data network | Detection | Management |
| DNN Data Network | EDGE Enhanced | Function |
| Name | Datarates for GSM | EGPRS Enhanced |
| DNAI Data Network | Evolution (GSM | GPRS |
| Access Identifier | Evolution) | EIR Equipment |
| DRB Data Radio | EAS Edge | Identity Register |
| Bearer | Application Server | eLAA enhanced |
| DRS Discovery | EASID Edge | Licensed Assisted |
| Reference Signal | Application Server | Access, |
| DRX Discontinuous | Identification | enhanced LAA |
| Reception | ECS Edge | EM Element |
| EMS Element | Configuration Server | Manager |
| Management System | E-UTRAN Evolved | eMBB Enhanced |
| eNB evolved NodeB, | UTRAN | Mobile |
| E-UTRAN Node B | EV2X Enhanced V2X | Broadband |
| 5 EN-DC E- | F1AP F1 Application | Division Multiplex |
| UTRA-NR Dual | Protocol | FDMA Frequency |
| Connectivity | F1-C F1 Control plane | Division Multiple |
| EPC Evolved Packet | interface | Access |
| Core | F1-U F1 User plane | FE Front End |
| EPDCCH enhanced | interface | FEC Forward Error |
| PDCCH, enhanced | FACCH Fast | Correction |
| Physical | Associated Control | FFS For Further |
| Downlink Control | CHannel | Study |
| Cannel | FACCH/F Fast | FFT Fast Fourier |
| EPRE Energy per | Associated Control | Transformation |
| resource element | Channel/Full | feLAA further enhanced |
| EPS Evolved Packet | rate | Licensed Assisted |
| System | FACCH/H Fast | Access, further |
| EREG enhanced REG, | Associated Control | enhanced LAA |
| enhanced resource | Channel/Half | FN Frame Number |
| element groups | rate | FPGA Field- |
| ETSI European | FACH Forward Access | Programmable Gate |
| Telecommunications | Channel | Array |
| Standards | FAUSCH Fast | FR Frequency |
| Institute | Uplink Signalling | Range |
| ETWS Earthquake and | Channel | FQDN Fully Qualified |
| Tsunami Warning | FB Functional Block | Domain Name |
| System | FBI Feedback | G-RNTI GERAN |
| eUICC embedded | Information | Radio Network |
| UICC, embedded | FCC Federal | Temporary |
| Universal | Communications | Identity |
| Integrated Circuit | Commission | GERAN |
| Card | FCCH Frequency | GSM EDGE |
| E-UTRA Evolved | Correction CHannel | RAN, GSM EDGE |
| 15 UTRA | FDD Frequency | Radio Access |
| GLONASS | Division Duplex | Network |
| GLObal'naya | GTP-UGPRS | GGSN Gateway GPRS |
| NAvigatsionnay | Tunnelling Protocol | Support Node |
| a Sputnikovaya | for User Plane | HSUPA High |
| Sistema (Engl. | GTS Go To Sleep | Speed Uplink Packet |
| Global Navigation | Signal (related to | Access |
| Satellite System) | WUS) | HTTP Hyper Text |
| gNB Next Generation | GUMMEI Globally | Transfer Protocol |
| NodeB | Unique MME Identifier | HTTPS Hyper |
| gNB-CU gNB- | GUTI Globally Unique | Text Transfer Protocol |
| centralized unit, Next | Temporary UE | Secure (https is |
| Generation | Identity | http/1.1 over |
| NodeB | HARQ Hybrid ARQ, | SSL, i.e. port 443) |
| centralized unit | Hybrid | I-Block |
| gNB-DU gNB- | Automatic | Information |
| distributed unit, Next | Repeat Request | Block |
| Generation | HANDO Handover | ICCID Integrated |
| NodeB | HFN HyperFrame | Circuit Card |
| distributed unit | Number | Identification |
| GNSS Global | HHO Hard Handover | IAB Integrated |
| Navigation Satellite | HLR Home Location | Access and Backhaul |
| System | Register | ICIC Inter-Cell |
| GPRS General Packet | HN Home Network | Interference |
| Radio Service | HO Handover | Coordination |
| GPSI Generic | HPLMN Home | ID Identity, |
| Public Subscription | Public Land Mobile | identifier |
| Identifier | Network | IDFT Inverse Discrete |
| GSM Global System | HSDPA High | Fourier |
| for Mobile | Speed Downlink | Transform |
| Communications, | Packet Access | IE Information |
| Groupe | HSN Hopping | element |
| Special | Sequence Number | IBE In-Band |
| Mobile | HSPA High Speed | Emission |
| GTP GPRS Tunneling | Packet Access | IEEE Institute of |
| Protocol | HSS Home | Electrical and |
| IEI Information | Subscriber Server | Electronics |
| Element Identifier | Ipsec IP Security, | Engineers |
| IEIDL Information | Internet Protocol | kB Kilobyte (1000 |
| Element Identifier | Security | bytes |
| Data Length | IP-CAN IP- | kbps kilo-bits per |
| IETF Internet | Connectivity Access | second |
| Engineering Task | Network | Kc Ciphering key |
| Force | IP-M IP Multicast | Ki Individual |
| IF Infrastructure | IPv4 Internet Protocol | subscriber |
| IIOT Industrial | Version 4 | authentication |
| Internet of Things | IPV6 Internet Protocol | key |
| IM Interference | Version 6 | KPI Key |
| Measurement, | IR Infrared | Performance Indicator |
| Intermodulation, | IS In Sync | KQI Key Quality |
| IP Multimedia | IRP Integration | Indicator |
| IMC IMS Credentials | Reference Point | KSI Key Set |
| IMEI International | ISDN Integrated | Identifier |
| Mobile | Services Digital | ksps kilo-symbols per |
| Equipment | Network | second |
| Identity | ISIM IM Services | KVM Kernel Virtual |
| IMGI International | Identity Module | Machine |
| mobile group identity | ISO International | L1 Layer 1 |
| IMPI IP Multimedia | Organisation for | (physical layer) |
| Private Identity | Standardisation | L1-RSRP Layer 1 |
| IMPU IP Multimedia | ISP Internet Service | reference signal |
| PUblic identity | Provider | received power |
| IMS IP Multimedia | IWF Interworking- | L2 Layer 2 (data |
| Subsystem | Function | link layer) |
| IMSI International | I-WLAN | L3 Layer 3 (network |
| Mobile | Interworking | layer) |
| Subscriber | WLAN | LAA Licensed |
| Identity | Constraint length | Assisted Access |
| IoT Internet of | of the convolutional | LAN Local Area |
| Things | code, USIM | Network |
| IP Internet Protocol | Individual key | LADN Local |
| LBT Listen Before | MAC Medium Access | Area Data Network |
| Talk | Control (protocol | MCOT Maximum |
| LCM LifeCycle | layering context) | Channel |
| Management | MAC Message | Occupancy Time |
| LCR Low Chip Rate | authentication code | MCS Modulation and |
| LCS Location | (security/encryption | coding scheme |
| Services | context) | MDAF Management |
| LCID Logical | MAC-A MAC | Data Analytics |
| Channel ID | used for | Function |
| LI Layer Indicator | authentication | MDAS Management |
| LLC Logical Link | and key | Data Analytics |
| Control, Low Layer | agreement (TSG | Service |
| Compatibility | T WG3 context) | MDT Minimization of |
| LMF Location | MAC-IMAC used for | Drive Tests |
| Management Function | data integrity of | ME Mobile |
| LOS Line of | signalling messages | Equipment |
| Sight | (TSG T WG3 context) | MeNB master eNB |
| LPLMN Local | MANO | MER Message Error |
| PLMN | Management and | Ratio |
| LPP LTE Positioning | Orchestration | MGL Measurement |
| Protocol | MBMS | Gap Length |
| LSB Least Significant | Multimedia | MGRP Measurement |
| Bit | Broadcast and Multicast | Gap Repetition |
| LTE Long Term | Service | Period |
| Evolution | MBSFN | MIB Master |
| LWA LTE-WLAN | Multimedia | Information Block, |
| aggregation | Broadcast multicast | Management |
| LWIP LTE/WLAN | service Single | Information Base |
| Radio Level | Frequency | MIMO Multiple Input |
| Integration with | Network | Multiple Output |
| IPsec Tunnel | MCC Mobile Country | MLC Mobile Location |
| LTE Long Term | Code | Centre |
| Evolution | MCG Master Cell | MM Mobility |
| M2M Machine-to- | Group | Management |
| Machine | MSIN Mobile Station | MME Mobility |
| MN Master Node | Identification | Management Entity |
| MNO Mobile | Number | NE-DC NR-E- |
| Network Operator | MSISDN Mobile | UTRA Dual |
| MO Measurement | Subscriber ISDN | Connectivity |
| Object, Mobile | Number | NEF Network |
| Originated | MT Mobile | Exposure Function |
| MPBCH MTC | Terminated, Mobile | NF Network |
| Physical Broadcast | Termination | Function |
| CHannel | MTC Machine-Type | NFP Network |
| MPDCCH MTC | Communications | Forwarding Path |
| Physical Downlink | mMTCmassive MTC, | NFPD Network |
| Control CHannel | massive Machine- | Forwarding Path |
| MPDSCH MTC | Type Communications | Descriptor |
| Physical Downlink | MU-MIMO Multi | NFV Network |
| Shared CHannel | User MIMO | Functions |
| MPRACH MTC | MWUS MTC | Virtualization |
| Physical Random | wake-up signal, MTC | NFVI NFV |
| Access CHannel | WUS | Infrastructure |
| MPUSCH MTC | NACK Negative | NFVO NFV |
| Physical Uplink Shared | Acknowledgement | Orchestrator |
| Channel | NAI Network Access | Next Generation, |
| MPLS MultiProtocol | Identifier | Next Gen |
| Label Switching | NAS Non-Access | NGEN-DC NG-RAN |
| MS Mobile Station | Stratum, Non-Access | E-UTRA-NR Dual |
| MSB Most Significant | Stratum layer | Connectivity |
| Bit | NCT Network | NM Network |
| MSC Mobile | Connectivity | Manager |
| Switching Centre | Topology | NMS Network |
| MSI Minimum | NC-JT Non- | Management System |
| System | Coherent Joint | N-POP Network Point of |
| Information, | Transmission | Presence |
| MCH Scheduling | NEC Network | NMIB, N-MIB |
| Information | Capability Exposure | Narrowband MIB |
| MSID Mobile Station | NSA Non-Standalone | NPBCH |
| Identifier | operation mode | Narrowband |
| Broadcast | NSD Network Service | Physical |
| CHannel | Descriptor | OSI Other System |
| NPDCCH | NSR Network Service | Information |
| Narrowband | Record | OSS Operations |
| Physical | NSSAINetwork Slice | Support System |
| Downlink | Selection | OTA over-the-air |
| Control CHannel | Assistance | PAPR Peak-to-Average |
| NPDSCH | Information | Power Ratio |
| Narrowband | S-NNSAI Single- | PAR Peak to Average |
| Physical | NSSAI | Ratio |
| Downlink | NSSF Network Slice | PBCH Physical |
| Shared CHannel | Selection Function | Broadcast Channel |
| NPRACH | NW Network | PC Power Control, |
| Narrowband | NWUSNarrowband | Personal |
| Physical Random | wake-up signal, | Computer |
| Access CHannel | Narrowband WUS | PCC Primary |
| NPUSCH | NZP Non-Zero Power | Component Carrier, |
| Narrowband | O&M Operation and | Primary CC |
| Physical Uplink | Maintenance | P-CSCF Proxy |
| Shared CHannel | ODU2 Optical channel | CSCF |
| NPSS Narrowband | Data Unit-type 2 | PCell Primary Cell |
| Primary | OFDM Orthogonal | PCI Physical Cell ID, |
| Synchronization | Frequency Division | Physical Cell |
| Signal | Multiplexing | Identity |
| NSSS Narrowband | OFDMA | PCEF Policy and |
| Secondary | Orthogonal | Charging |
| Synchronization | Frequency Division | Enforcement |
| Signal | Multiple Access | Function |
| NR New Radio, | OOB Out-of-band | PCF Policy Control |
| Neighbour Relation | OOS Out of Sync | Function |
| NRF NF Repository | OPEX OPerating | PCRF Policy Control |
| Function | EXpense | and Charging Rules |
| NRS Narrowband | PNFD Physical | Function |
| Reference Signal | Network Function | PDCP Packet Data |
| NS Network Service | Descriptor | Convergence Protocol, |
| Convergence | PNFR Physical | Packet Data |
| Protocol layer | Network Function | PSCCH Physical |
| PDCCH Physical | Record | Sidelink Control |
| Downlink Control | POC PTT over | Channel |
| Channel | Cellular | PSSCH Physical |
| PDCP Packet Data | PP, PTP Point-to- | Sidelink Shared |
| Convergence Protocol | Point | Channel |
| PDN Packet Data | PPP Point-to-Point | PSCell Primary SCell |
| Network, Public | Protocol | PSS Primary |
| Data Network | PRACH Physical | Synchronization |
| PDSCH Physical | RACH | Signal |
| Downlink Shared | PRB Physical | PSTN Public Switched |
| Channel | resource block | Telephone Network |
| PDU Protocol Data | PRG Physical | PT-RS Phase-tracking |
| Unit | resource block | reference signal |
| PEI Permanent | group | PTT Push-to-Talk |
| Equipment | ProSe Proximity | PUCCH Physical |
| Identifiers | Services, | Uplink Control |
| PFD Packet Flow | Proximity-Based | Channel |
| Description | Service | PUSCH Physical |
| P-GW PDN Gateway | PRS Positioning | Uplink Shared |
| PHICH Physical | Reference Signal | Channel |
| hybrid-ARQ indicator | PRR Packet | QAM Quadrature |
| channel | Reception Radio | Amplitude |
| PHY Physical layer | PS Packet Services | Modulation |
| PLMN Public Land | PSBCH Physical | QCI QoS class of |
| Mobile Network | Sidelink Broadcast | identifier |
| PIN Personal | Channel | QCL Quasi co- |
| Identification Number | PSDCH Physical | location |
| PM Performance | Sidelink Downlink | QFI QOS Flow ID, |
| Measurement | Channel | QOS Flow Identifier |
| PMI Precoding | RL Radio Link | QOS Quality of |
| Matrix Indicator | RLC Radio Link | Service |
| PNF Physical | Control, Radio | QPSK Quadrature |
| Network Function | Link Control | (Quaternary) Phase |
| QZSS Quasi-Zenith | layer | Shift Keying |
| Satellite System | RLC AM RLC | RRC Radio Resource |
| RA-RNTI Random | Acknowledged Mode | Control, Radio |
| Access RNTI | RLC UM RLC | Resource Control |
| RAB Radio Access | Unacknowledged Mode | layer |
| Bearer, Random | RLF Radio Link | RRM Radio Resource |
| Access Burst | Failure | Management |
| RACH Random Access | RLM Radio Link | RS Reference Signal |
| Channel | Monitoring | RSRP Reference Signal |
| RADIUS Remote | RLM-RS | Received Power |
| Authentication Dial In | Reference Signal | RSRQ Reference Signal |
| User Service | for RLM | Received Quality |
| RAN Radio Access | RM Registration | RSSI Received Signal |
| Network | Management | Strength Indicator |
| RAND RANDom | RMC Reference | RSU Road Side Unit |
| number (used for | Measurement Channel | RSTD Reference Signal |
| authentication) | RMSI Remaining MSI, | Time difference |
| RAR Random Access | Remaining | RTP Real Time |
| Response | Minimum | Protocol |
| RAT Radio Access | System | RTS Ready-To-Send |
| Technology | Information | RTT Round Trip |
| RAU Routing Area | RN Relay Node | Time |
| Update | RNC Radio Network | Rx Reception, |
| RB Resource block, | Controller | Receiving, Receiver |
| Radio Bearer | RNL Radio Network | S1AP S1 Application |
| RBG Resource block | Layer | Protocol |
| group | RNTI Radio Network | S1-MME S1 for the |
| REG Resource | Temporary Identifier | control plane |
| Element Group | ROHC RObust Header | S1-U S1 for the user |
| Rel Release | Compression | plane |
| REQ REQuest | SDAP Service Data | S-CSCF serving |
| RF Radio Frequency | Adaptation Protocol, | CSCF |
| RI Rank Indicator | Service Data | S-GW Serving Gateway |
| RIV Resource | Adaptation | S-RNTI SRNC |
| indicator value | Protocol layer | Radio Network |
| Temporary | SDL Supplementary | SI System |
| Identity | Downlink | Information |
| S-TMSI SAE | SDNF Structured Data | SI-RNTI System |
| Temporary Mobile | Storage Network | Information RNTI |
| Station Identifier | Function | SIB System |
| SA Standalone | SDP Session | Information Block |
| operation mode | Description Protocol | SIM Subscriber |
| SAE System | SDSF Structured Data | Identity Module |
| Architecture Evolution | Storage Function | SIP Session Initiated |
| SAP Service Access | SDT Small Data | Protocol |
| Point | Transmission | SiP System in |
| SAPD Service Access | SDU Service Data | Package |
| Point Descriptor | Unit | SL Sidelink |
| SAPI Service Access | SEAF Security Anchor | SLA Service Level |
| Point Identifier | Function | Agreement |
| SCC Secondary | SeNB secondary eNB | SM Session |
| Component Carrier, | SEPP Security Edge | Management |
| Secondary CC | Protection Proxy | SMF Session |
| SCell Secondary Cell | SFI Slot format | Management Function |
| SCEF Service | indication | SMS Short Message |
| Capability Exposure | SFTD Space-Frequency | Service |
| Function | Time Diversity, SFN | SMSF SMS Function |
| SC-FDMA Single | and frame timing | SMTC SSB-based |
| Carrier Frequency | difference | Measurement Timing |
| Division | SFN System Frame | Configuration |
| Multiple Access | Number | SN Secondary Node, |
| SCG Secondary Cell | SgNB Secondary gNB | Sequence Number |
| Group | SGSN Serving GPRS | SoC System on Chip |
| SCM Security Context | Support Node | SON Self-Organizing |
| Management | S-GW Serving Gateway | Network |
| SCS Subcarrier | Signal based Signal to | SpCell Special Cell |
| Spacing | Noise and Interference | SP-CSI-RNTISemi- |
| SCTP Stream Control | Ratio | Persistent CSI RNTI |
| Transmission | SSS Secondary | SPS Semi-Persistent |
| Protocol | Synchronization | Scheduling |
| SQN Sequence | Signal | Communication |
| number | SSSG Search Space Set | Protocol |
| SR Scheduling | Group | TDD Time Division |
| Request | SSSIF Search Space Set | Duplex |
| SRB Signalling Radio | Indicator | TDM Time Division |
| Bearer | SST Slice/Service | Multiplexing |
| SRS Sounding | Types | TDMA Time Division |
| Reference Signal | SU-MIMO Single | Multiple Access |
| SS Synchronization | User MIMO | TE Terminal |
| Signal | SUL Supplementary | Equipment |
| SSB Synchronization | Uplink | TEID Tunnel End |
| Signal Block | TA Timing | Point Identifier |
| SSID Service Set | Advance, Tracking | TFT Traffic Flow |
| Identifier | Area | Template |
| SS/PBCH Block | TAC Tracking Area | TMSI Temporary |
| SSBRI SS/PBCH Block | Code | Mobile |
| Resource Indicator, | TAG Timing Advance | Subscriber |
| Synchronization | Group | Identity |
| Signal Block | TAI Tracking | TNL Transport |
| Resource Indicator | Area Identity | Network Layer |
| SSC Session and | TAU Tracking Area | TPC Transmit Power |
| Service | Update | Control |
| Continuity | TB Transport Block | TPMI Transmitted |
| SS-RSRP | TBS Transport Block | Precoding Matrix |
| Synchronization | Size | Indicator |
| Signal based | TBD To Be Defined | TR Technical Report |
| Reference Signal | TCI Transmission | TRP, TRxP |
| Received Power | Configuration Indicator | Transmission |
| SS-RSRQ | UMTS Universal | Reception Point |
| Synchronization | Mobile | TRS Tracking |
| Signal based | Telecommunications | Reference Signal |
| Reference Signal | System | TRx Transceiver |
| Received Quality | UP User Plane | TS Technical |
| SS-SINR | UPF User Plane | Specifications, |
| Synchronization | Function | V2X Vehicle-to- |
| Technical | URI Uniform | everything |
| Standard | Resource Identifier | VIM Virtualized |
| TTI Transmission | URL Uniform | Infrastructure Manager |
| Time Interval | Resource Locator | VL Virtual Link, |
| Tx Transmission, | URLLC Ultra- | VLAN Virtual LAN, |
| Transmitting, | Reliable and Low | Virtual Local Area |
| Transmitter | Latency | Network |
| U-RNTI UTRAN | USB Universal Serial | VM Virtual Machine |
| Radio Network | Bus | VNF Virtualized |
| Temporary | USIM Universal | Network Function |
| Identity | Subscriber Identity | VNFFG VNF |
| UART Universal | Module | Forwarding Graph |
| Asynchronous | USS UE-specific | VNFFGD VNF |
| Receiver and | search space | Forwarding Graph |
| Transmitter | UTRA UMTS | Descriptor |
| UCI Uplink Control | Terrestrial Radio | VNFM VNF Manager |
| Information | Access | VOIP Voice-over-IP, |
| UE User Equipment | UTRAN Universal | Voice-over-Internet |
| UDM Unified Data | Terrestrial Radio | Protocol |
| Management | Access Network | VPLMN Visited |
| UDP User Datagram | UwPTS Uplink | Public Land Mobile |
| Protocol | Pilot Time Slot | Network |
| UDSF Unstructured | V2I Vehicle-to- | VPN Virtual Private |
| Data Storage Network | Infrastruction | Network |
| Function | V2P Vehicle-to- | VRB Virtual Resource |
| UICC Universal | Pedestrian | Block |
| Integrated Circuit | V2V Vehicle-to- | WiMAX |
| Card | Vehicle | Worldwide |
| UL Uplink | | Interoperability |
| UM | | for Microwave |
| Unacknowledged | | Access |
| Mode | | WLANWireless Local |
| UML Unified | | Area Network |
| Modelling Language | | |
| WMAN Wireless | | |
| Metropolitan Area | | |
| Network | | |
| WPANWireless | | |
| Personal Area Network | | |
| X2-C X2-Control | | |
| plane | | |
| X2-U X2-User plane | | |
| XML extensible | | |
| Markup Language | | |
| XRES Expected user | | |
| RESponse | | |
| XOR exclusive OR | | |
| ZC Zadoff-Chu | | |
| ZP Zero Power | | |

### Terminology

For the purposes of the present document, the following terms and definitions are applicable to the examples and embodiments discussed herein.

The term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, and/or transferring digital data. Processing circuitry may include one or more processing cores to execute instructions and one or more memory structures to store program and data information. The term “processor circuitry” may refer to one or more application processors, one or more baseband processors, a physical central processing unit (CPU), a single-core processor, a dual-core processor, a triple-core processor, a quad-core processor, and/or any other device capable of executing or otherwise operating computer-executable instructions, such as program code, software modules, and/or functional processes. Processing circuitry may include more hardware accelerators, which may be microprocessors, programmable processing devices, or the like. The one or more hardware accelerators may include, for example, computer vision (CV) and/or deep learning (DL) accelerators. The terms “application circuitry” and/or “baseband circuitry” may be considered synonymous to, and may be referred to as, “processor circuitry.”

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, and/or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “network element” as used herein refers to physical or virtualized equipment and/or infrastructure used to provide wired or wireless communication network services. The term “network element” may be considered synonymous to and/or referred to as a networked computer, networking hardware, network equipment, network node, router, switch, hub, bridge, radio network controller, RAN device, RAN node, gateway, server, virtualized VNF, NFVI, and/or the like.

The term “computer system” as used herein refers to any type interconnected electronic devices, computer devices, or components thereof. Additionally, the term “computer system” and/or “system” may refer to various components of a computer that are communicatively coupled with one another. Furthermore, the term “computer system” and/or “system” may refer to multiple computer devices and/or multiple computing systems that are communicatively coupled with one another and configured to share computing and/or networking resources.

The term “appliance,” “computer appliance,” or the like, as used herein refers to a computer device or computer system with program code (e.g., software or firmware) that is specifically designed to provide a specific computing resource. A “virtual appliance” is a virtual machine image to be implemented by a hypervisor-equipped device that virtualizes or emulates a computer appliance or otherwise is dedicated to provide a specific computing resource.

The term “resource” as used herein refers to a physical or virtual device, a physical or virtual component within a computing environment, and/or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, and/or the like. A “hardware resource” may refer to compute, storage, and/or network resources provided by physical hardware element(s). A “virtualized resource” may refer to compute, storage, and/or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing and/or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with and/or equivalent to “communications channel,” “data communications channel,” “transmission channel,” “data transmission channel,” “access channel,” “data access channel,” “link,” “data link,” “carrier,” “radiofrequency carrier,” and/or any other like term denoting a pathway or medium through which data is communicated. Additionally, the term “link” as used herein refers to a connection between two devices through a RAT for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or link, and/or the like.

The term “information element” refers to a structural element containing one or more fields. The term “field” refers to individual contents of an information element, or a data element that contains content.

The term “SMTC” refers to an SSB-based measurement timing configuration configured by SSB-MeasurementTimingConfiguration.

The term “SSB” refers to an SS/PBCH block.

The term “a “Primary Cell” refers to the MCG cell, operating on the primary frequency, in which the UE either performs the initial connection establishment procedure or initiates the connection re-establishment procedure.

The term “Primary SCG Cell” refers to the SCG cell in which the UE performs random access when performing the Reconfiguration with Sync procedure for DC operation.

The term “Secondary Cell” refers to a cell providing additional radio resources on top of a Special Cell for a UE configured with CA.

The term “Secondary Cell Group” refers to the subset of serving cells comprising the PSCell and zero or more secondary cells for a UE configured with DC.

The term “Serving Cell” refers to the primary cell for a UE in RRC_CONNECTED not configured with CA/DC there is only one serving cell comprising of the primary cell.

The term “serving cell” or “serving cells” refers to the set of cells comprising the Special Cell(s) and all secondary cells for a UE in RRC_CONNECTED configured with CA/.

The term “Special Cell” refers to the PCell of the MCG or the PSCell of the SCG for DC operation; otherwise, the term “Special Cell” refers to the Pcell.

1.-21. (canceled)

22. An apparatus to be implemented in a next generation Node B (gNB), the apparatus comprising:
memory to store configuration information for a Msg3 physical uplink shared channel (PUSCH) repetition by a user equipment (UE); and
processor circuitry, coupled with the memory, to:
retrieve the configuration information from memory, wherein the configuration information includes an indication of separate random access channel (RACH) occasions (ROs) associated with the Msg3 PUSCH repetition for UEs requesting the Msg3 PUSCH repetition and UEs not requesting the Msg3 PUSCH repetition; and
encode a message that includes the configuration information for transmission to the UE.

23. The apparatus of claim 22, wherein the Msg3 PUSCH repetition is associated with a four-step RACH procedure.

24. The apparatus of claim 22, wherein the configuration information includes an indication of: a PRACH root sequence index, a zero-correlation zone configuration, a restricted set configuration, a total number of preambles available for a request of a Msg3 PUSCH repetition, a Msg1 frequency division multiplexing (FDM), or a Msg1 frequency start.

25. The apparatus of claim 22, wherein the configuration includes an indication of a parameter for an association between a synchronization signal block (SSB) and an RO.

26. The apparatus of claim 22, wherein the configuration information includes an indication of a plurality of PRACH formats.

27. The apparatus of claim 22, wherein the configuration information is to indicate an initial uplink (UL) bandwidth part (BWP) for a reduced capability (RedCap) UE.

28. The apparatus of claim 27, wherein the configuration information includes a PRACH preamble partitioning for the RedCap UE.

29. One or more non-transitory computer-readable media storing instructions that, when executed by one or more processors, cause a next-generation NodeB (gNB) to:
determine configuration information for a Msg3 physical uplink shared channel (PUSCH) repetition associated with a four-step RACH procedure by a user equipment (UE), wherein the configuration information includes an indication of separate random access channel (RACH) occasions (ROs) associated with the Msg3 PUSCH repetition for UEs requesting the Msg3 PUSCH repetition and UEs not requesting the Msg3 PUSCH repetition; and
encode a message that includes the configuration information for transmission to the UE.

30. The one or more non-transitory computer-readable media of claim 29, wherein the configuration information includes an indication of: a PRACH root sequence index, a zero-correlation zone configuration, a restricted set configuration, a total number of preambles available for a request of a Msg3 PUSCH repetition, a Msg1 frequency division multiplexing (FDM), or a Msg1 frequency start.

31. The one or more non-transitory computer-readable media of claim 29, wherein the configuration includes an indication of a parameter for an association between a synchronization signal block (SSB) and an RO.

32. The one or more non-transitory computer-readable media of claim 29, wherein the configuration information includes an indication of a plurality of PRACH formats.

33. The one or more non-transitory computer-readable media of claim 29, wherein the configuration information is to indicate an initial uplink (UL) bandwidth part (BWP) for a reduced capability (RedCap) UE.

34. The one or more non-transitory computer-readable media of claim 33, wherein the configuration information includes a PRACH preamble partitioning for the RedCap UE.

35. One or more non-transitory computer-readable media storing instructions that, when executed by one or more processors, cause a next-generation NodeB (gNB) to:
determine configuration information for a Msg3 physical uplink shared channel (PUSCH) repetition by a user equipment (UE), wherein the configuration information includes an indication of shared random access channel (RACH) occasions (ROs) associated with the Msg3 PUSCH repetition for UEs requesting the Msg3 PUSCH repetition and UEs not requesting the Msg3 PUSCH repetition, and wherein the configuration information includes an indication of separate physical random access channel (PRACH) preambles associated with the shared RACH ROs for the UEs requesting the Msg3 PUSCH repetition and the UEs not requesting the Msg3 PUSCH repetition; and
encode a message that includes the configuration information for transmission to the UE.

36. The one or more non-transitory computer-readable media of claim 35, wherein the configuration information includes an indication of a total number of contention-based random access (CBRA) preambles and a total number of contention-free random access (CFRA) preambles.

37. The one or more non-transitory computer-readable media of claim 36, wherein the PRACH preambles for the UEs requesting the Msg3 PUSCH repetition are allocated after the CBRA preambles.

38. The one or more non-transitory computer-readable media of claim 36, wherein the CBRA preambles are associated with a two-step RACH procedure or a four-step RACH procedure.

39. The one or more non-transitory computer-readable media of claim 35, wherein the configuration information includes an indication of a set of PRACH preambles associated with a synchronization signal block (SSB).

40. The one or more non-transitory computer-readable media of claim 35, wherein the configuration information is to indicate an initial uplink (UL) bandwidth part (BWP) for a reduced capability (RedCap) UE.

41. The one or more non-transitory computer-readable media of claim 40, wherein the configuration information includes a PRACH preamble partitioning for the RedCap UE.
